(19) United States
(12) Patent Application Publication
(10) Pub. No.: US 2010/0315989 A1
(43) Pub. Date: Dec. 16, 2010

(54) METHOD AND APPARATUS FOR COOPERATIVE RELAYING IN WIRELESS COMMUNICATIONS

(75) Inventors: Alexander Reznik, Titusville, NJ (US); Eldad M. Zeira, Huntington, NY (US); Mihaela C. Beluri, Huntington, NY (US); Sana Sfar, King of Prussia, PA (US); Zinan Lin, Melville, NY (US); Mohammed Sammour, Alrabieh (JO); Prabhakar R. Chitrapu, Blue Bell, PA (US)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/498,805

(22) Filed: Jul. 7, 2009

Related U.S. Application Data
(60) Provisional application No. 61/078,655, filed on Jul. 7, 2008.
(60) Provisional application No. 61/094,764, filed on Sep. 5, 2008.
(60) Provisional application No. 61/098,678, filed on Sep. 19, 2008.

(51) Int. Cl. H04B 7/14

(52) U.S. Cl. 370/315

(57) ABSTRACT

A method and apparatus for cooperative relaying in wireless communications is provided. An efficient and simplified relay scheme is disclosed that transitions between different modes on a per packet basis using scheduling information or switching information included in the packet, without requiring link reconfiguration. The cooperative relay scheme benefits further from the use of cooperative relaying protocols that emphasize centralized scheduling. One protocol emphasizes physical layer cooperation via synchronized transmissions and distributed space-time coding and the other protocol emphasizes medium access control (MAC) layer cooperation using different MAC flows or messages.

### CROSS REFERENCE TO RELATED APPLICATIONS

This application claims the benefit of U.S. provisional application No. 61/078,655, filed Jul. 7, 2008; U.S. provisional application No. 61/094,764, filed Sep. 5, 2008; and U.S. provisional application No. 61/098,678, filed Sep. 19, 2008, each of which is incorporated by reference as if fully set forth.

### FIELD OF INVENTION

This application is related to wireless communications.

### BACKGROUND

The introduction of relaying into cellular systems opens up new operational possibilities for optimization of system operation as well as new challenges associated with efficient operation of such systems. A major feature which needs addressing is the management of scheduling and feedback across the transmitter of origin, i.e., base station (BS) or wireless transmit/receive unit (WTRU) and the relay stations (RS). The appropriate design choices in these cases depend greatly on which relaying method is adopted. The challenges and trade-offs may be illustrated by considering a simple example: downlink (DL) transmission with only a single relay: BS→RS→WTRU.

In some wireless communication environments, certain areas may be devoid of wireless signals due to the transmission patterns of beams carrying the wireless signal. In other scenarios, an intended receiver of the wireless signal may be in a location beyond the range of the transmitting device. In these situations, a 2-hop system of transmission is used by establishing a RS that serves as a receiver for a BS transmitting the original signal, then as a transmitter for a WTRU. The signal intended for the WTRU is transmitted by the BS, received by the RS and forwarded to the WTRU as the intended recipient. In effect, the RS acts as the WTRU for the BS and the BS for the WTRU. On the other hand, in cases where a 2-hop transmission is not required, the RS may still serve as a (potentially transparent) helper to the BS to increase the data rate at which the signal may be sent from the BS to the WTRU.

In general, the communication between the BS and the WTRU occurs in 2 phases. In the first phase, the BS sends a communication and the WTRU listens if possible. The RS listens as well. In phase 2, which may or may not be needed, the RS sends the communication and the WTRU listens. The BS may or may not cooperate. The option to cooperate, remain silent or use radio resources for other purposes is decided by the BS.

The link between the BS, the RS and the WTRU may be in one of three defined states. The first state is direct. In the direct state, phase one is sufficient for the WTRU to successfully receive data and phase two is not necessary. In other words, the intended recipient is within communication range of the originating BS and the RS is not needed. The second state is multicast. In a multicast state, the WTRU can receive scheduling information directly from the BS in phase one and the BS can receive feedback directly from the WTRU in phase one but cooperation between the BS and the RS, in communication with the WTRU, may be necessary. The last state is the 2-hop state. In the 2-hop state, there is no direct link between the BS and the WTRU on the DL so the scheduling information cannot be successfully received by the WTRU. Likewise, there is no direct link between the WTRU and the BS on the uplink (UL) so feedback cannot be received directly at the BS. In some situations, the DL may be in one state and/or mode while the UL may be in a different state and/or mode. In cases where the UL and the DL are in different states, the worst case state between the UL and the DL is assumed.

The 2-hop state includes a non-cooperative 2-hop mode and cooperative 2-hop mode. In the non-cooperative 2-hop mode, the BS sends information to the RS. Once the RS receives this information the RS sends the information to the WTRU without any further assistance from the BS. This mode is clearly appropriate for coverage extension either beyond the cell edge, or into “black holes”—areas within the cell (e.g. inside buildings) where the BS signal does not penetrate. There are 2 choices for hybrid automatic repeat request (HARQ) scheduling and feedback for the non-cooperative 2-hop mode. In the first, the BS retains control over scheduling. This is called centralized scheduling. However, centralized scheduling has certain downsides. For one, the BS is required to use signaling overhead to schedule the RS transmission after the RS has the data. Also, the acknowledgment (ACK) feedback (which may be available only at the RS) must be relayed to the BS, which results both in overhead and delays in data delivery. An alternative approach is to allow the RS to schedule data transmission to the WTRU autonomously once it acknowledges receipt of data to the BS, called distributed scheduling. Distributed scheduling avoids the 2 issues mentioned above, and in the case of the non-cooperative 2-hop mode, it may be the more efficient method of operation.

It is well known that RSs can provide significant quality of service (QoS) benefit to WTRUs that are within “range” of the BS but are experiencing degraded performance. For example, WTRUs at a cell edge where interference is the primary limitation on performance and the BS-RS link is comparable to the BS-WTRU link. To do so, the RS must cooperate with the BS in transmitting to the WTRU. For example, once the RS has the data, the BS and RS transmit cooperatively, forming a distributed transmit antenna array in either an open or closed loop. This arrangement is referred to as the cooperative 2-hop mode (or coop 2-hop). Clearly, distributed scheduling is not appropriate for the coop 2-hop mode as the coordination required may only be achieved with centralized scheduling. Existing system designs support both a distributed and a centralized mode of operation.

Feedback must also be considered in deciding the state and/or mode. Each hop of feedback introduces additional delay into the HARQ operation which preferably should be minimized. Consequently feedback for the non-cooperative 2-hop mode is frequently performed by reverting to distributed scheduling (in which case the BS never gets feedback from the WTRU). Under the coop 2-hop mode this is not possible because the BS must get the feedback.

Because of the inherent mobility of the WTRU, it is likely to transition between situations where one of the states and/or modes described herein is preferred. In wireless communications such as high-speed packet access (HSPA), long term evolution (LTE) or IEEE 802.16 and the WiMAX standard technology built using 802.16, signaling occurs at the network physical layer. To accomplish a transition between states and/or modes in the physical layer (PHY) or the medium access control layer (MAC), a link reconfiguration needs to be performed. This switching between the two is generally done using out-of-band control signaling. In many scenarios the need for such switching may occur rather frequently as WTRUs move, thereby making the process cumbersome, slow and expensive with regard to overhead.

Reconfiguration issues can be demonstrated with respect to the introduction of RSs to IEEE 802.16 via the 802.16j amendment. Two RS operation modes, transparent and non-transparent have been introduced. A non-transparent RS transmits DL frame-start, channel definition messages such as frame control header (FCH), downlink channel descriptor (DCD), and uplink channel descriptor (UCD) and all scheduling information. A transparent RS does not transmit these. A transition between the two modes is clearly difficult. Each mode must be examined separately to see if one mode is able to meet all the requirements. Although different RSs may co-exist within a cell, reconfiguring a particular RS is a major task.

For example, the transparent mode is clearly well-suited to support the multicast state of relaying operation. However, it does not provide for re-transmission of signaling, and therefore cannot support the 2-hop state of operation. For this reason, a dynamic transition of a CCID assisted by a transparent RS from multicast to 2-hop states is not possible. Additionally, non-transparent operation may be required for cooperation between the BS and RS in Phase 2 because that cooperation using either distributed space-time block codes/frequency block codes or distributed spatial multiplexing requires the WTRU to perform channel estimation for both the BS-WTRU and the RS/-WTRU link. To enable channel estimation at the WTRU, the RS needs to use specific reference symbols orthogonal to the BS reference symbols, thus the WTRU has to be aware of the presence of the RS. To meet the requirements set forth above, the non-transparent mode is therefore used as a basis for an enhanced method of transmitting scheduling information in the DL.

Regarding the handling of feedback in this model, an ACK or non-acknowledgement (NACK) is not forwarded to the BS until the RS knows what the feedback is. This creates a number of problems that may need to be addressed. The first is that a delay lasting for more than one TTI may be associated with this operation. Second, a transition to 2-hop operation is generally carried out for coverage extension or black hole coverage. In these cases, the signal from the BS to the WTRU is non-existent or at least severely suppressed. In such cases, signaling from the BS is not received by the WTRU. This may be handled but it must be done at a higher layer, for example by performing a handover. A centralized scheduled RS, whether transparent or non-transparent will wait for an ACK/NACK that is not forthcoming. Other existing or developing cellular standards suffer from similar problems in regard to their utilization of relaying.

Consequently, modern cellular systems introducing relays will benefit from an improved scheduling and switching scheme that allows a seamless transition between multiple modes of operation, minimizes delay, does not require link reconfiguration and provides the benefits of centralized.

### SUMMARY

A method and apparatus for cooperative relaying in wireless communications is provided. An efficient and simplified relay scheme is disclosed that transitions between different modes on a per packet basis using scheduling information or switching information included in the packet, without requiring link reconfiguration. The cooperative relay scheme benefits further from the use of cooperative relaying protocols that emphasize centralized scheduling. One protocol emphasizes physical layer cooperation via synchronized transmissions and distributed space-time coding and the other protocol emphasizes medium access control (MAC) layer cooperation using different MAC flows or messages.

### BRIEF DESCRIPTION OF THE DRAWINGS

A more detailed understanding may be had from the following description, given by way of example in conjunction with the accompanying drawings wherein:

FIG. 1 shows a wireless communication system/access network of Long Term Evolution (LTE);

FIG. 2 is a functional block diagram of a wireless transmit/receive unit (WTRU), the base station and the Mobility Management Entity/Serving Gateway (MME/S-GW) of the wireless communication system of FIG. 2;

FIG. 3 is an embodiment of a state diagram of a single relay packet transmission;

FIG. 4 is an illustration of cooperation between a base station and a relay station;

FIG. 5 shows a 2-hop structure embodiment for signaling in the downlink;

FIG. 6 shows a 3-hop structure embodiment for signaling in the downlink;

FIG. 7 is a flowchart of a method of hybrid automatic repeat request (HARQ) scheduling embodiment;

FIG. 8 illustrates a cooperative multiplexing scheme;

FIG. 9 shows an embodiment of a downlink (DL) architecture for Protocol 1;

FIG. 10 shows an embodiment of a DL architecture for Protocol 2;

FIG. 11 shows a control channel embodiment for DL;

FIG. 12 shows a control channel embodiment for uplink (UL);

FIG. 13 shows another control channel embodiment for UL;

FIG. 14 shows a Protocol 2 HARQ Scheme embodiment with a Base Station (BS), Relay Station (RS) and WTRU;

FIG. 15 shows another Protocol 2 HARQ Scheme embodiment;

FIG. 16 shows another Protocol 2 HARQ Scheme embodiment;

FIG. 17 shows another Protocol 2 HARQ Scheme embodiment;

FIG. 18 shows another Protocol 2 HARQ Scheme embodiment;

FIG. 19 shows another Protocol 2 HARQ Scheme embodiment;

FIG. 20 shows another Protocol 2 HARQ Scheme embodiment;

FIG. 21 shows a Protocol 1 HARQ Scheme embodiment; and

FIG. 22 shows another Protocol 1 HARQ Scheme embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a base station (BS), an evolved Node B (eNB), a site controller, an access point (AP), or any other type of interfacing device capable of operating in a wireless environment.

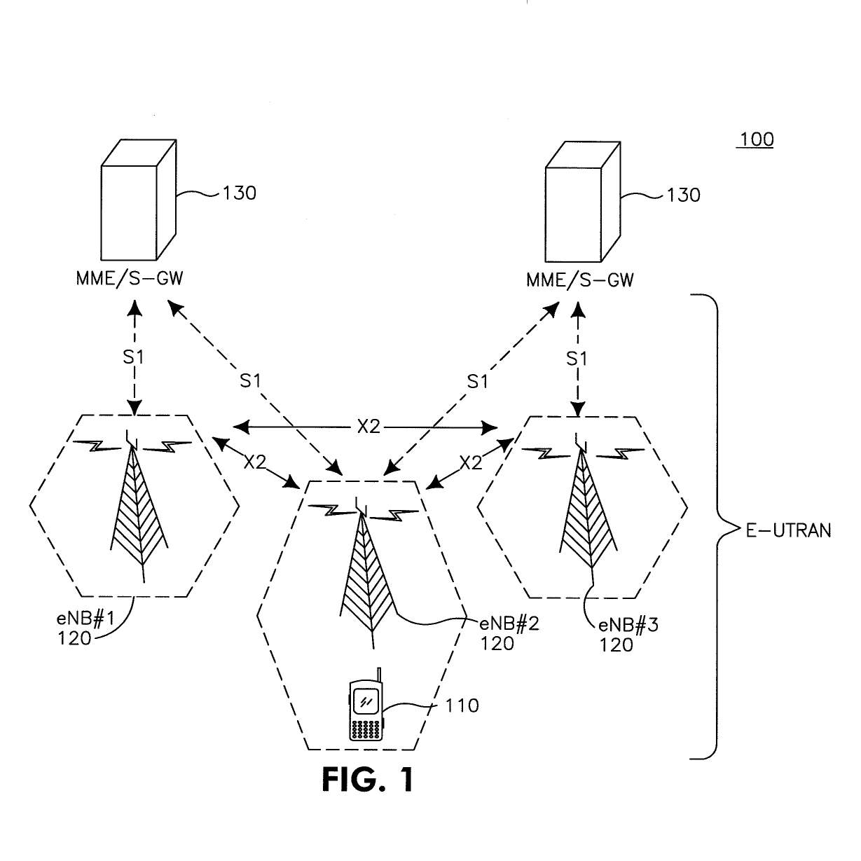

FIG. 1 shows a wireless communication system/access network of Long Term Evolution (LTE) 100, which includes an Evolved-Universal Terrestrial Radio Access Network (E-UTRAN). The E-UTRAN as shown, includes a WTRU 110 and a BS, for example, such as several evolved Node Bs (eNBs) 120. As shown in FIG. 1, the WTRU 110 is in communication with an eNB 120. The eNBs 120 interface with each other using an X2 interface. The eNBs 120 are also connected to a Mobility Management Entity (MME)/Serving GateWay (S-GW) 130, through an S1 interface. Although a single WTRU 110 and three eNBs 120 are shown in FIG. 1, it should be apparent that any combination of wireless and wired devices may be included in the wireless communication system 100. Although an LTE wireless communication system/access network is shown, any wireless communication system/access network is applicable such as, but not limited to, high-speed packet access (HSPA) or IEEE 802.16 (WiMAX).

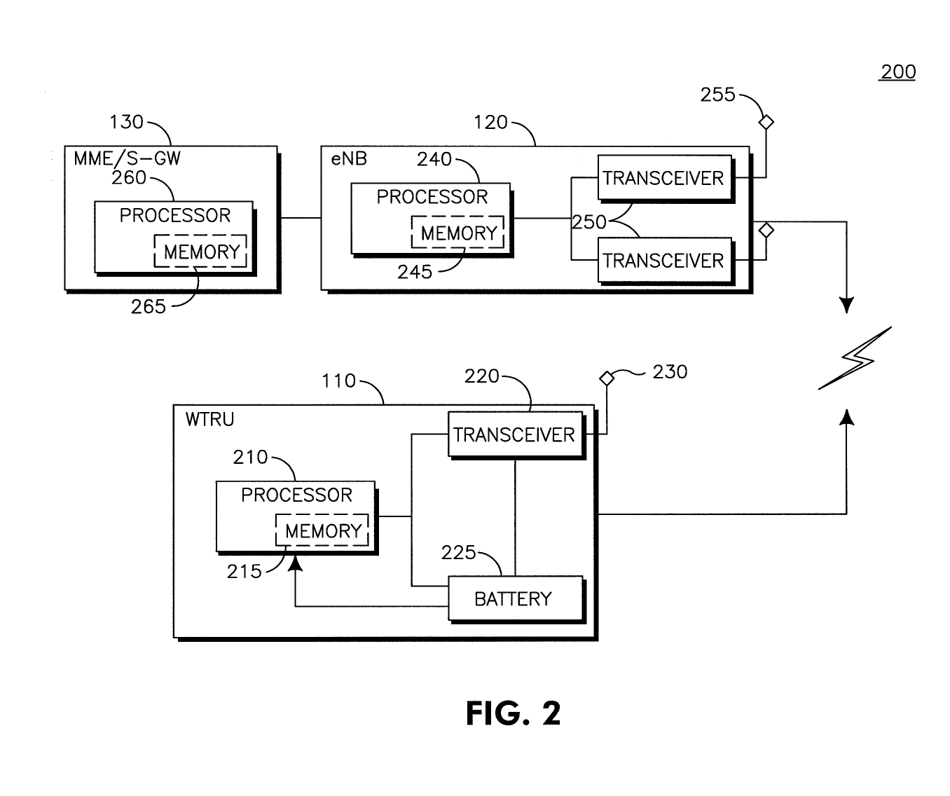

FIG. 2 is an example block diagram 200 of the WTRU 110, the eNB 120, and the MME/S-GW 130 of the wireless communication system 100 of FIG. 1. As shown in FIG. 2, the WTRU 110, the eNB 120 and the MME/S-GW 130 are configured to perform a method for cooperative relaying in wireless communications.

In addition to the components that may be found in a typical WTRU, the WTRU 110 includes a processor 210 with an optional linked memory 215, a transmitter and receiver together designated as transceiver 220, an optional battery 225, and an antenna 230 (the antenna may be two or more units). The processor 210 is configured to perform a method for cooperative relaying in wireless communications. The transceiver 220 is in communication with the processor 210 to facilitate the transmission and reception of wireless communications. In case the battery 225 is used in WTRU 110, it powers both the transceiver 220 and the processor 210.

In addition to the components that may be found in a typical eNB, the eNB 120 includes a processor 240 with an optional linked memory 245, transceivers 250, and antennas 255. The processor 240 is configured to perform a method for cooperative relaying in wireless communications. The transceivers 255 are in communication with the processor 240 and antennas 255 to facilitate the transmission and reception of wireless communications. The eNB 120 is connected to the Mobility Management Entity/Serving-GateWay (MME/S-GW) 130 which includes a processor 260 with an optional linked memory 265.

Discussed herein are embodiments for scheduling and switching between multiple modes and/or states such as for example, centralized and distributed scheduling. Also disclosed are embodiments for cooperative centralized scheduling.

At the onset is described certain illustrative assumptions for transmitting and receiving transmissions in relayed packet communications. When a WTRU is scheduled to receive a transmission within a transmission time interval (TTI), the WTRU will send an acknowledgement (ACK) or a non-acknowledgement (NACK) for every TTI in which there was a transmission scheduled to the WTRU and the WTRU was able to successfully receive scheduling information scheduling such transmissions.

A NACK may be either explicit or implicit. In the case of an implicit NACK, the exact timing, location (e.g., sub-carrier or channel) of ACK/NACK feedback must be known and these are associated with a specific connection component ID (CCID). An implicit (non-transmitted) NACK may be used in the following ways. A NACK may never be sent; only an ACK is transmitted as feedback to the BS. In this scenario, an absence of an ACK is interpreted by the BS or RS as a NACK. In another scenario, the WTRU always sends an actual NACK. When this option is used, an absence of a NACK at the BS or RS is interpreted in one of the following ways. It may be interpreted as an implicit NACK with no further significance attached, an implicit NACK and an indication that there may be a problem with the link to the WTRU, or an implicit NACK on the data and the scheduling information.

For the case of an explicit NACK, there are two possible options. First the exact timing and the location may be known. In this case, a specific CCID does not need to be transmitted. This allows for the ACK/NACK to be transmitted in a one bit burst. In the second option, the exact timing and/or location is not known. In this case, the CCID must be communicated with the ACK/NACK. Moreover, the transmission timing might be further constrained by the need to meet hybrid automatic repeat request (HARQ) latency constraints.

Feedback associated with the channel state, such as channel quality indicator (CQI), physical channel identifier (PCI) and feedback information (FBI) are transmitted as needed.

The following assumptions may be made with respect to relay operations. It may be assumed that the RS operates only to decode and forward communications. Alternatively, the RS may be configured to receive feedback from the receiving WTRU except when the link quality does not allow it. To use this option, scheduling must take this additional feedback communication into account. The RS may be aware of CCIDs that are associated with it. Alternatively, the association of a CCID to the RS may be semi-static. With respect to feedback from the RS, the RS may send a relay acknowledgement (R-ACK) or a relay non-acknowledgement (R-NACK) associated with each CCID. The same options relating to implicit and explicit NACK discussed above applies to an R-NACK. The receiving WTRU may not receive feedback from the RS. The RS sends feedback information related to the BS-RS channel. The RS may be configured to forward feedback from the WTRU to the BS. Synchronization between the BS and RS transmissions to the WTRU in phase two operations may be present, although the use of the synchronization is optional.

In relay packet communications, the following requirements should be met to ensure successful reception of all signaling as appropriate in a given mode. In the multicast mode, the total HARQ delay will be the same as the HARQ delay in a no-relay system and the BS and RS shall be able to synchronize transmissions in Phase 2 (but may not be required to do so). In direct mode, the RS shall not make any transmissions for the CCID and the total HARQ delay will be the same as in a no-relay system.

Dynamic transition (per-TTI) between multicast and 2-hop modes shall be supported for each CCID associated with a RS. Dynamic transition (per-TTI) between multicast mode and direct mode shall be supported for each CCID associated with a RS. TTIs within a frame are allocated to Phase 1, Phase 2, or Relay Guard Time (RGT).

At least one RGT must be allocated whenever transition between Phase 1 and Phase 2 occurs within a frame. If guard times are already present at frame boundaries, RGT does not need to be allocated when the Phase 1/Phase 2 transition occurs at frame boundary. The allocation of TTIs is dynamic; however RGT occurrence is minimized.

There are 3 types of scheduling schemes possible that address the unique needs of relays and HARQ with relays. In one embodiment, a synchronous scheme is used. All HARQ processes are completely synchronous, so the RS knows everything after the first transmission of each protocol data unit (PDU). In another embodiment, an asynchronous scheme is used. This may be consistent with current DL in HSPA and LTE in part, however, a scheme is required so that the RS can read the scheduling information and then switch to transmit in Phase 2. In another embodiment, a scheduled scheme is used. This scheme accommodates the RS. It is not synchronous in that the BS figures out in advance when re-transmissions will be scheduled if needed and sends this info with the first transmission. Once the WTRU sends an ACK, the BS is no longer locked in, i.e., this only locks in the BS over a short term.

Under either the synchronous or scheduled operation, after the first transmission, the RS knows when it is supposed to transmit and will do so as soon as it transitions to Phase 2 and until it receives an ACK from the WTRU.

Regarding asynchronous operation, consider independent scheduling by the RS first. This approach for a 2-hop configuration provides no means to synchronize the BS and the RS, which violates the assumptions provided above. On the other hand, if it can be easily enabled as needed, this option may be retained. It should be noted, however, a key characteristic must be the transmission of scheduling info by the RS. Without this, graceful transition from multicast (where BS transmits signaling) to 2-hop (where the RS must transmit signaling) is not possible.

In the asynchronous embodiment this is accomplished by having the BS schedule the RS transmission in sync with itself. This is done using a TTI where the RS listens, presumably once per frame. The scheduling “word” may include a list of HARQ Process IDs (including WTRU ID). For each HARQ Process ID, it may also include TTI and sub-carrier (as required). And depending on specific data transmission scheme, channel state information (CSI), modulation code scheme (MCS), PCI may be included for each HARQ Process ID.

The downlink map (DL MAP) is transmitted once per frame. An additional relay map (RL MAP) can be scheduled with information for the relay listening period.

The scheme also allows fairly flexible partitioning of the RS receive/transmit (Rx/Tx) intervals per frame. The RS is required to listen to its scheduling word (and thus to at least 1 TTI per frame). From this it reads a list of all TTIs for when it is supposed to transmit. It is required to receive for all other TTIs. Clearly this allows synchronization of transmission.

To default to the 2-hop mode, 2 options are enabled. In a BS-controlled option, once the RS ACKs (i.e. in Phase 2), the BS schedules the WTRU as above. However it does not actually transmit to the WTRU using the schedule provided to the RS. It can either not use the corresponding radio resource or use the radio resource for something else, presumably controlling cross-interference. In a RS-controlled option, while in phase 1, the scheduling information is augmented with a RS-control-indicator bit (RSCI). If the RSCI is set, the RS is allowed to independently schedule re-transmission of the given HARQ process.

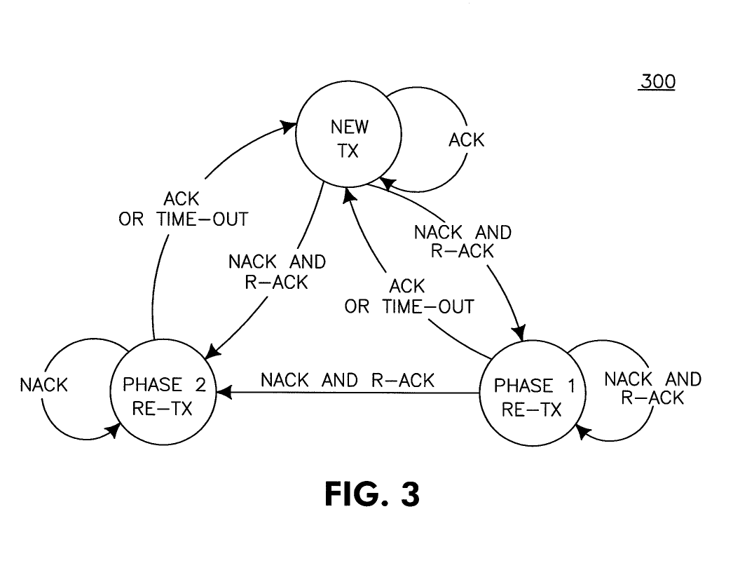

For the single-relay system disclosed herein there is a 3-state procedure as illustrated in the state transition diagram 300 in FIG. 3. As shown in FIG. 3, every time there is new data to be sent, the transmission process for that particular CCID (i.e. that HARQ process part of the connection) starts in the “New Tx” state at which point a single transmission is in a TTI allocated to Phase 1. If the WTRU sends an ACK for the transmission, the system returns immediately to the “New Tx” state for transmission of a new data packet. In fact, as soon as the WTRU ACKs the transmission for this CCID, it returns to that state. Additionally, a “time-out” condition is defined as either 1) reaching the maximal time for a transmission and/or 2) reaching the maximal number of re-transmission attempts. If this occurs, the system returns to the “New Tx” state as well. Otherwise, the operation depends on the RS. In one instance, the system is in “Phase 1 re-Tx” state where re-transmissions are scheduled in Phase 1 until the RS sends an ACK. As soon the RS ACKs, the system goes into the “Phase 2 re-Tx” state where re-transmissions are scheduled for Phase 2.

While the operation is described above in terms of having only 1 RS, operation with any number of RSs is possible in a similar manner by defining “synchronized relay sets” (SRS) as a set of relays that operate in sync, i.e. these either all receive or all transmit together. For each SRS, its own R-ACK and R-NACK are defined and each gets an equivalent of “Phase 2 Re-Tx” state in a modified state diagram. Moreover, for each SRS, phases are defined in which (for now there are more then 2) the RSs listen or transmit. The SRS definitions do not lead to contradictions (i.e. requiring the same RS to listen and receive at the same time as a member of different SRSs). This places constraints on SRS definitions which need to be satisfied.

The system transitions to a state associated with an SRS when all the relays in that SRS have R-ACK'ed and no other overriding conditions (such as a mobile ACK) have occurred. The state determines which of the phases the data is re-transmitted in and thus the frame structure.

In regard to feedback, there are some conflicting issues which need to be resolved. In a 2-hop system, the RS needs to forward ACK/NACK (though not any other info, as any info about the RS-WTRU channel is irrelevant in this case). When the BS-WTRU link is present, the BS should be able to detect feedback directly from the WTRU and not suffer the delay associated with forwarding by the RS.

A scheme should gracefully transition between the two. The WTRU transmits a single feedback channel not a separate one for each link. Thus, if the BS is able to receive it, it has all the channel state info as well as ACK/NACK. This is transmitted at a higher power to allow the BS to receive without assistance from the RS; however the power differential is limited.

The issue that needs to be resolved is what the RS does with feedback and how does the network respond to it. First consider the situation, where the RS always forwards the feedback back to the BS (or in the case of multiple RSs, to the “previous” RS). In this case, there are two options for network operations. First, the BS waits for feedback from the RS. This may be problematic because of the associated additional delay for HARQ operation. In fact, for certain delay-sensitive applications (VoIP), the delay may not be tolerable. Second, if the BS receives the original feedback (from the WTRU), it acts upon it immediately (e.g. re-transmits, if it is a NACK). In this case, the BS ignores the re-transmitted feedback from the RS. The RS then needs to expect the re-transmission and cooperate if needed—i.e. the RS needs to operate under the assumption that its feedback will be too late and will be ignored. This approach has a smaller disadvantage in that the uplink bandwidth may be wasted forwarding unnecessary feedback. However, it solves the delay problem in the multicast mode.

The approaches disclosed herein allow for a seamless transition to a simple 2-hop system in case the direct link between the BS and the WTRU is down. In the second approach, provisions need to be made for the BS to detect that there is no direct link from the WTRU in order to start using the ACK/NACK feedback information relayed by the RS.

In both cases, the feedback from the RS may be done on a per-WTRU channel (which will allow the WTRU to cooperate with the RS in the transmission of feedback in the uplink). Alternately, a separate channel may be defined for the RS to pool all the feedback and send them back all at once.

If the delay reduction advantage is to be retained but wasting bandwidth in the uplink is to be avoided, an alternate approach may be used. This comes at the cost of some downlink bandwidth in lieu of wasting the uplink bandwidth.

In the alternative approach, the RS does not automatically forward feedback. An exception may be in the case where the RS is allowed to schedule autonomously, in which case it always forwards, but only ACK/NACK (presumably because scheduling in the RS implies a 2-hop system). If a RS receives a re-transmission for HARQ processes which it knows has been ACK'ed, it sends the ACK back and does not transmit anything (i.e. does not introduce unnecessary interference). If a joint closed-loop beamforming/precoding/multi-stream multiple-input multiple-output (MIMO) scheme is employed, the RS may be required (via link signaling) to forward back any channel state info as well. This is likely bundled into a special “relay feedback channel.”

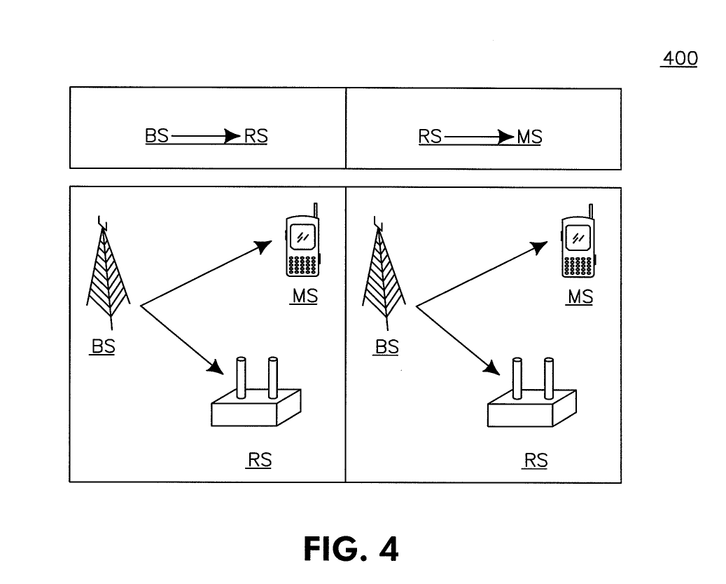

An embodiment of a cooperative scheme 400 between the BS and a non-transparent RS is illustrated in FIG. 4. The embodiment comprises 2 steps. First, in the downlink, the BS transmits data to the RS. The WTRU should ideally have sufficient scheduling information and extracts partial information from this step. In the second step, both the BS and the non-transparent RS transmit data to the WTRU associated with the RS using either distributed space-time block codes (STBC)/space-frequency block codes (SFBC), distributed spatial multiplexing, or other technique.

The first step behavior may be used under any propagation regime, but is optimal for below rooftop RS deployment where the BS-RS channel is non-line of sight (non-LOS). For this strategy to work it is necessary that the BS and RS coordinate their scheduling and resource usage. The exact scheduling of the transmission, power and transport format determination would be up to the scheduler, however sufficient information must be provided to all nodes. This scheme can be extended to multiple (more that 2) hops. A similar scheme may be applied to uplink RSs.

The scheme presented above will be referred to as multicast cooperation (MC), where the term “multicast” is used to indicate that the WTRU is listening to the BS transmission during the DL relay zone, and the term “cooperation” is used to indicate that during the DL access zone, both the BS and the RS are transmitting data to the WTRU, using either distributed STBC/SFBC or distributed spatial multiplexing. A key requirement for the MC scheme is to be able to seamlessly transition to a simple 2-hop scheme in case there is no direct link between the BS and WTRU. It should be noted that the MC scheme is effective in certain scenarios, as indicated above. It should be able to transition to a simple 2-hop scheme in case the direct link between the BS and WTRU is not present. The use of MC has implications on scheduling (centralized versus distributed), as well as on the control signaling to the WTRU (being either relayed or received directly from the BS). That transition should not require high reliability signaling.

The MC scheme may be implemented in the framework of a time-separated frame structure. This is explained with respect to the BS behavior, Odd-hop RS behavior, Even-hop RS behavior and WTRU behavior, respectively. In the DL Relay Zone of the DL sub-frame, the BS can transmit to subordinate RS and the WTRU directly attached to the BS (BS behavior); the RS receives from its super-ordinate station (Odd-hop RS behavior); the RS transmits to sub-ordinate RSs and/or to the WTRUs directly attached to the current RS (Even-hop RS behavior); and the WTRU attached to an odd-hop RS may listen to the transmission from the BS (if the WTRU is attached to a first-hop RS) or to the super-ordinate RS (if the WTRU is attached to a third hop RS) (WTRU behavior).

In the DL Access Zone of the DL sub-frame, the BS transmits to the WTRU directly attached to the BS and/or to the WTRU directly attached to the first hop RS (BS behavior); the RS transmits to sub-ordinate RSs and/or to the WTRUs directly attached to the current RS (Odd-hop RS behavior); the RS receives from its super-ordinate station (Even-hop RS behavior); and the WTRU receives data from the RS to which it is attached and from its super ordinate node (BS if it is attached to odd RS, odd RS if it is attached to even RS) (WTRU behavior).

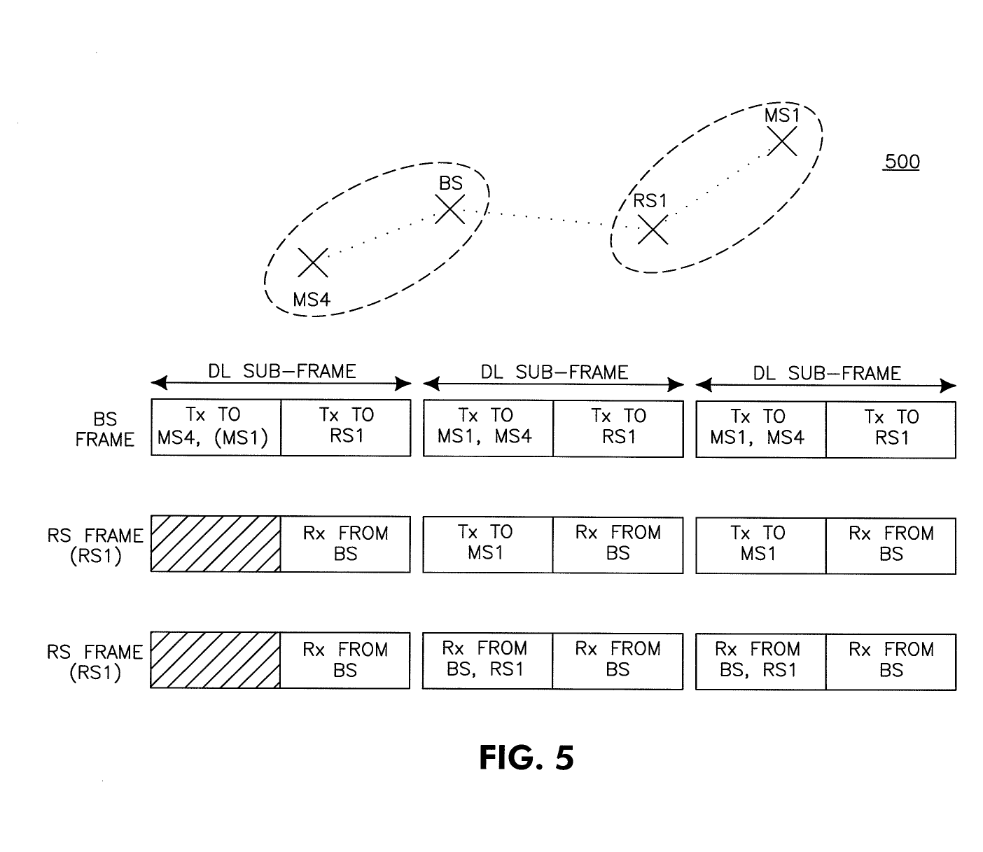

An example of the frame structure usage to configure MC for a 2-hop case 500 is illustrated in FIG. 5. In FIG. 5, WTRU1 is attached to RS 1, and WTRU4 is directly attached to the BS. To simplify the picture, only the DL sub-frames are shown. In the first DL sub-frame, the BS transmits to WTRU1, WTRU4 (first half) and RS 1 (second half); and RS 1 and WTRU1 receives the first BS transmission (second half). In the second DL sub-frame, the BS transmits to WTRU1, WTRU4 (first half) and RS 1 (second half); RS 1 transmits to WTRU1 (first half) and receives second transmission from BS (second half); and the WTRU1 receives the second BS and first RS 1 transmissions (first half) and receives a third transmission from the BS (second half). This pattern then repeats itself.

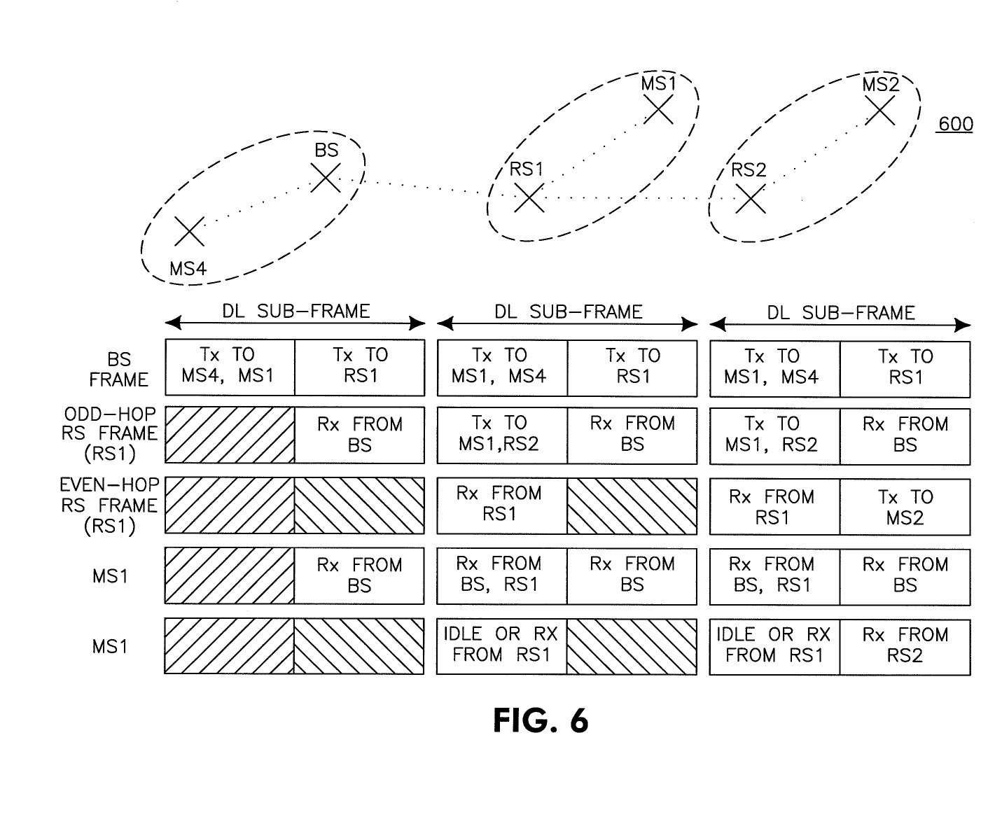

An example of a 3-hop case 600 is shown in FIG. 6, where WTRU2 is attached to RS2, WTRU1 is attached to RS 1 and WTRU4 is directly attached to the BS. In the first DL sub-frame, the BS transmits to WTRU1, WTRU4 (first half) and RS 1 (second half); RS 1 receives the first BS transmission (second half); RS2 has no activity in this sub-frame; WTRU1 receives the first BS transmission (second half); and WTRU2 has no activity in this sub-frame. In the first DL sub-frame, the BS transmits to WTRU1, WTRU4 (first half) and RS 1 (second half); RS 1 receives the first BS transmission (second half); RS2 has no activity in this sub-frame; WTRU1 receives the first BS transmission (second half); and WTRU2 has no activity in this sub-frame.

In the second DL sub-frame, the BS transmits to WTRU1, WTRU4 (first half) and RS 1 (second half); RS 1 transmits to WTRU1 and RS2 (first half) and receives a second BS transmission (second half); RS2 receives a transmission from RS 1 (first half); WTRU1 receives a second BS and the first RS 1 transmission (first half) and receives a third BS transmission (second half); and WTRU2 has no activity in this sub-frame or receives a transmission from RS 1 (first half).

In the third DL sub-frame, the BS transmits to WTRU1, WTRU4 (first half) and RS 1 (second half); RS 1 transmits to WTRU1 and RS2 (first half) and receives another BS transmission (second half); RS2 receives a transmission from RS 1 (first half) and transmits to WTRU2 (second half); WTRU1 receives another BS and RS 1 transmission (first half) and receives another BS transmission (second half); and WTRU2 has no activity in this sub-frame or receives a transmission from RS 1 (first half) and receives a transmission from RS2 (second half). This pattern then repeats itself.

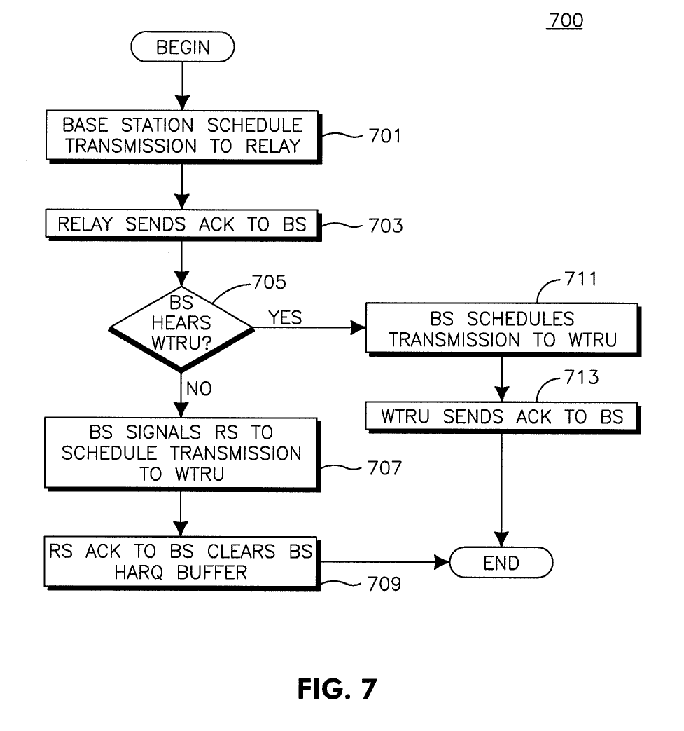

Referring now to FIG. 7, there is shown a flowchart 700 for seamless transitioning between centralized and distributed scheduling. For the purposes of this description it is assumed that the association and connection remain static (i.e. mobility and inter-relay “handover” are not addressed here).

Consider first the non-cooperative 2-hop case of a BS-RS-WTRU connection. In the downlink, a transmission is scheduled to the RS (701). Upon successful reception the RS sends a HARQ ACK to the BS (703). The BS behavior depends on whether a WTRU is associated with it, (i.e. whether they can hear each others physical or L1 signaling) (705).

If the WTRU is associated with the BS, the BS continues to schedule transmissions to the WTRU thus allowing the BS and RS to cooperate (711). Because the WTRU is associated with the BS, no ACK relaying by the RS is necessary because the BS should be able to receive it. It should be noted that cooperation is not required; the BS can schedule a transmission (thus forcing the RS to transmit), while not sending to that WTRU at the scheduled time.

If the WTRU is not associated with the BS, the BS will signal to the RS to take over scheduling as soon as it receives the data (707). It treats the RS HARQ ACK as an ACK from the WTRU and removes the data from its HARQ buffer (709).

The signaling of scheduling mode to the RS may be done in several ways e.g. by including a special field with each burst control information field or by sending a special control field following the reception of the burst. It can also be a link property in which case it does not need to be signaled.

The general multi-hop case will now be considered. Starting with a tree-based relaying architecture, an association root node (ARN) is defined for a WTRU as follows. If the WTRU is associated with the BS then the BS is the ARN for that WTRU. Otherwise, an RS is the ARN for a WTRU if none of its super-ordinate nodes (RSs and BS) in the defined path to that WTRU are associated with the WTRU.

The definition of ARN has the following key meaning—an ARN node is the lowest index node (in the relaying order) which has a viable direct over-the-air signaling connection to and from the WTRU. Consequently the ARN and all of its sub-ordinate nodes should cooperate in transmissions to the WTRU. All of ARNs super-ordinate nodes should employ multi-hop at least through the ARN to transmit to the WTRU. A further consequence of this is that ARN should be allowed to schedule transmission to the WTRU independently (distributed mode) from all its super-ordinate nodes, while all of ARN sub-ordinate nodes need to be centrally scheduled by the ARN.

The definition of the ARN allows a simple reduction of the multi-hop case to the 2-hop case discussed above. Specifically, if the BS is the ARN, then centralized scheduling of the WTRU can be used for the complete path. Moreover, the BS and WTRU can receive each other's feedback and no additional delay is incurred.

Otherwise, the BS-ARN-WTRU interaction is defined in the same manner as the BS-RS-WTRU interaction for the 2-hop case. Specifically, the ARN sends an ACK to the transmitter (BS in the downlink, WTRU in the uplink) and is then able to take over control of transmission for the rest of the hop. Because the WTRU is associated to the ARN, feedback and scheduling between ARN and WTRU suffer a delay of only 1 hop.

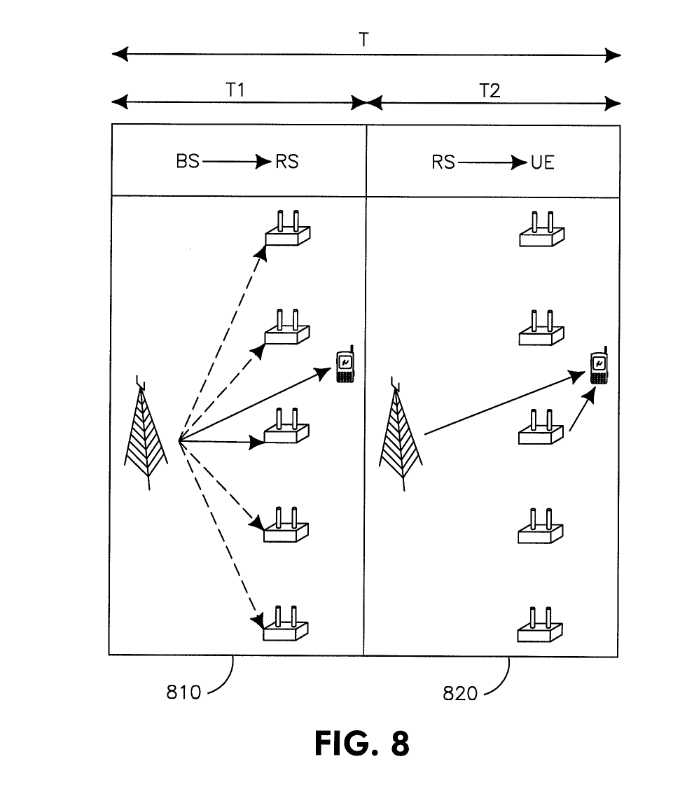

Another embodiment in implementing simplified, centralized relay architecture provides a cooperative protocol between the BS, RS and WTRU that is applicable to both the uplink and downlink operation of the WTRU. As discussed herein, the protocol embodiments consist of two basic phases as shown in FIG. 8. In Phase 1 (810), the BS transmits. The purpose of this transmission is to get data to the RS; however the WTRU behaves opportunistically and receives this transmission as well. This maximizes the throughput in all cases considered even if the WTRU does not receive a transmission in Phase 1 (810).

In Phase 2 (820), the RS transmits the data which it received in Phase 1 (810). The behavior of the BS in Phase 2 (820) depends on the protocol used. The behavior of the WTRU also depends on the protocol. Transmission occurs in fixed transmission time intervals (TTIs) of length T, as shown in FIG. 8. Intervals are partitioned flexibly into T1 for Phase 1 (810) and T2 for Phase 2 (820). Although T1 and T2 (representing Phase 1 (810) and Phase 2 (820)) are drawn contiguously in FIG. 8, T2 does not need to be contiguous to T1. In fact, in some practical systems, T2 will probably not be contiguous to T1. Channel conditions determine partitioning. For example, the transmission medium may be slotted into TTIs of fixed or variable size and changed dynamically.

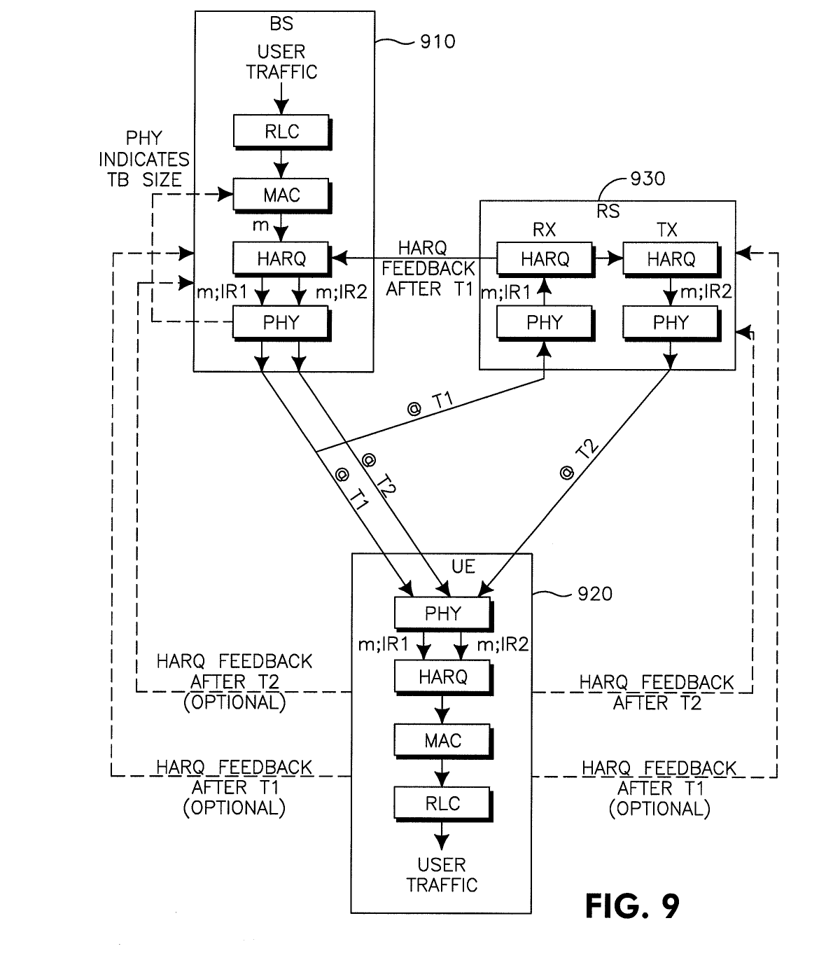

Protocol 1 (P1), as shown in FIG. 9, is defined as follows for the Downlink (DL): Given a message of m bits, the BS 910 encodes the m bits at a rate R1,BS;RS and transmits these in Phase 1. Since the RS 930 must successfully decode all data, m must follow the equation, m≦R_{1,BS,RS}T₁

In Phase 2, the BS 910 and RS 930 utilize a distributed space-time code layered with an incremental redundancy encoding of the data to transmit the data to the WTRU 920. The WTRU 920 uses its (optimal) space time decoder and then combines the two incrementally redundant transmissions to fully decode the data at the end of Phase 2. The WTRU 920 combines data from 2 transmissions to successfully decode. Let R_{1,BS,UE} be the maximal rate at which the reliable transmission from BS 910 to WTRU 920 is possible. Let R_{2,COOP} be the maximal rate at which reliable transmission to UE is possible by cooperation of RS 920 and BS 910 in Phase 2. Assuming ideal incremental redundancy combining, the WTRU 920 possesses bits of useful information about the message from the first transmission and R_{2,COOP}T₂ bits of useful information about the message from the second transmission. To successfully decode, m must therefore have m*m≦R_{1,BS,RS}T₁+R_{2,COOP,RS}T_{2,2}. The maximum amount of data that can be transmitted during the TTI (time T) is then given by:

m*=maxmin(R_{1,BS,RS}T₁,R_{2,coop}T₂+R_{1,BS,UE}Td₁) (1)

To maximize (1)

R_{1,BS,RS}T₁=R_{2,coop}T₂+R_{1,BS,UE}T₁ (2)

and this rate-balancing equation allows determination of both the split of the TTI into Phase 1 and Phase 2 and the maximal achievable transmission rate. The maximal achievable rate is:

$$\begin{matrix}{R}_{P 1} = \frac{{m}^{*}}{T} \\ = \frac{{R}_{1 , BS , RS} {R}_{2 , coop}}{{R}_{1 , BS , RS} + {R}_{2 , coop} - {R}_{1 , BS , UE}} \\ = \frac{1}{\frac{1}{{R}_{1 , BS , RS}} + \frac{1}{{R}_{2 , coop}} ( 1 - \frac{{R}_{1 , BS , UE}}{{R}_{1 , BS , RS}} )}\end{matrix} \qquad ( 3 )$$

Protocol 1 (P1) is also applicable for Uplink (UL). The figure/drawing should be similar to that shown in FIG. 9, but with switching/re-labeling the BS as the WTRU, and the WTRU as the BS. In the uplink, the WTRU creates a message/packet m. Such message can be in the form of a Medium Access Layer Control (MAC) Protocol Data Units (PDU), or in any other form. In Phase 1 (e.g. in a first TTI), WTRU transmits m to the RS and the BS preferably using a Modulation and Coding Scheme (MCS) suitable for the WTRU-RS link. The BS also listens to this transmission in Phase 1.

In Phase 2 (e.g. in a later TTI) the WTRU and the RS transmit m to the BS (preferably using a distributed space-time code, and preferably transmitting a different Incremental Redundancy (IR) version than the one transmitted in Phase 1).

The BS uses an appropriate receiver (e.g. (optimal) space time decoder) in Phase 2. Since m can have multiple IR versions received (e.g. in Phase I and Phase 2), the BS combines the received versions (e.g. HARQ combining) in order to improve the decoding of m.

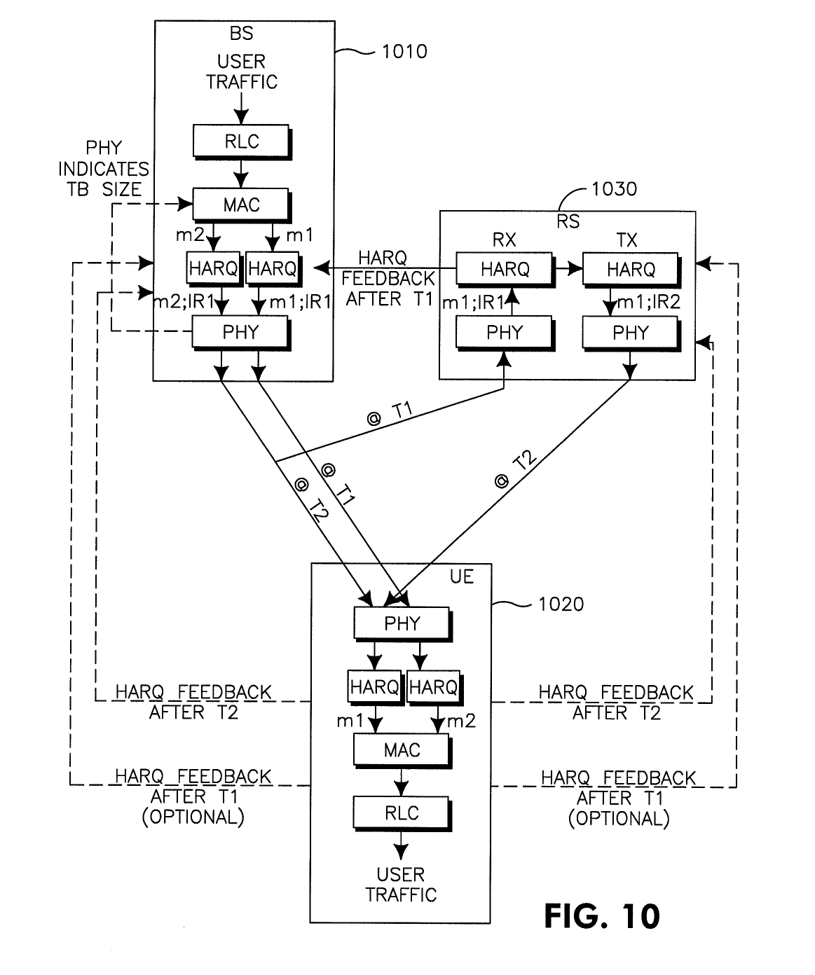

Protocol 2 (P2), as shown in FIG. 10, is defined as follows for the DL case. The BS 1010 creates two messages of m₁ and m₂ bits. Alternatively, these may be two pre-existing messages (e.g., MAC PDUs either from the same or different MAC flows). In Phase 1, BS 1010 transmits the first message (m₁ bits) to the RS 1030 at a rate R_{1,BS,RS}, thus m₁=R_{1,BS,RS} T₁. As in P1, the WTRU 1020 listens to this transmission. In Phase 2 the RS 1030 forwards the information it received in Phase 1 to the WTRU 1020. This is done at a rate R_{2,RS,UE}. Simultaneously the BS 1010 sends the second message (m₂ bits) to the WTRU 1020. This is done at a rate R_{2,BS,UE}. The WTRU 1020 uses an optimal multi-user detector (i.e. SIC) in Phase 2 and also optimal incremental redundancy for the first message to receive the data.

To analyze performance of these protocols, various constraints exist. First, as for P1, transmit the first message efficiently and therefore have the following rate-balancing equation:

R_{1,BS,RS}T₁=R_{2,RS,UE}T₂+R_{1,BS,UE}T₁ (4)

The rates R_{1,RS,UE} and R_{2,BS,UE} are, however, dependent on each other as well. In addition to satisfying individual per-link capacity constraints, these must also satisfy the MAC capacity constraint:

R_{2,RS,UE}+R_{2,BS,UE}≦R_{2,coop} (5)

The assumed rate R_{2,COOP} as defined for P1 is indeed the optimal transmitter cooperation rate. Although cooperation at the PHY layer is not part of P2, equation (5) illustrates the close relationship between achievable throughput for P1 and P2. Clearly, maximizing the throughput would require (5) to be satisfied with equality. Taking this together with (4) and the constraint T=T₁+T₂:

$$\begin{matrix}{R}_{P 2} = \frac{{m}_{1} + {m}_{2}}{T} \\ = \frac{{R}_{1 , BS , RS} {R}_{2 , coop} - {R}_{1 , BS , UE} {R}_{2 , BS , UE}}{{R}_{1 , BS , RS} + {R}_{2 , RS , UE} - {R}_{1 , BS , UE}}\end{matrix} \qquad ( 6 )$$

In typical interference limited cellular deployments P2 provides slightly better performance then P1. Both provide a significant improvement over a no-relay case or a simple 2-hop relaying and in fact P2 performs somewhat better then P1. The key difference is in the management of cooperation. In Protocol 1, a single message is transmitted by the MAC during (T1+T2), while Protocol 2 creates and transmits 2 MAC messages essentially independently (the transmissions are time synchronized).

Specifically, when utilizing P1, in order to schedule the data, the MAC needs to be aware of the quality of a compound link comprised of the three (3) constituent PHY links (BS-to-RS, RS-to-WTRU and BS-to-WTRU). Moreover, to ensure cooperation between BS and RS in Phase 2, the RS must be centrally scheduled by the BS and the PHY at BS and RS must be tightly synchronized to the channel symbol level.

Protocol 2 manages the transmission of the two flows almost independently and without tight PHY layer synchronization. A constraint on the two flows is that the sum rate at the WTRU does not exceed its sum-rate constraint (5). Provided this constraint is satisfied, the BS MAC manages the RS transmission only in a limited fashion. In particular, the BS MAC needs to schedule data to the RS (based only on the BS-to-RS link quality) to make sure that the RS buffer does not become empty. The BS and RS MACs need to agree how the rates are repartitioned in Phase 2 so that the combined rate to the WTRU does not violate (5). However, the BS MAC does not need to specify to the RS MAC which particular packet is to be scheduled for the transmission. Once the RS indicates reception of a packet, HARQ management for that packet can be relinquished to the RS.

Therefore, the RS MAC scheduler can act independently from the BS MAC scheduler with BS control of RS taking place at a slower rate. The PHY layer operations of Protocol 2 require no coordination since the BS and RS simply transmit different flows in Phase 2 in a non-cooperative fashion.

Protocol 2 (P2) is also applicable to UL. The figure/drawing should be similar to that shown in FIG. 10 but with switching/re-labeling the BS as the WTRU, and the WTRU as the BS. The WTRU creates any two messages/packets m1 and m2 (Note: m1 and m2 may be created at different times). Such two messages can be in the form of 2 MAC PDUs, or in any other form. In Phase 1 (e.g. in a first TTI), WTRU transmits m1 to the RS and the BS (preferably using an MCS suitable for the WTRU-RS link). The BS also listens to this transmission in Phase 1.

In Phase 2 (e.g. in a later TTI) the RS forwards the information it received in Phase 1 to the BS (preferably using a MCS suitable for the RS-BS link, and preferably transmitting a different IR version than the one it received from the WTRU). In addition, the WTRU sends a second message m2 to the BS (preferably using an MCS suitable for the WTRU-BS link). The BS uses an appropriate receiver (e.g. optimal multi-user detector (i.e. SIC)) in Phase 2 to receive m1 and m2. Since some messages (e.g. m1) can have multiple IR versions received (e.g. in Phase I and Phase 2), the BS combines the received versions (e.g. HARQ combining) in order to improve the decoding of the message.

The following control channel architecture can be used in conjunction with both Protocol 2 and Protocol 1. Two types of control channels are described herein. Transmission control channels (TCCs) describe or provide information about the associated (data) transmissions. For example, describing when transmissions will occur, the MCS, new transmissions or retransmissions, IR version, etc. . . . . The HARQ control channels describe or provide information about the reception status. For example, HARQ ACK/NACK feedback to indicate whether a transmission was received successfully (ACK), unsuccessfully (NACK) or not received (DTX; i.e. no feedback is transmitted).

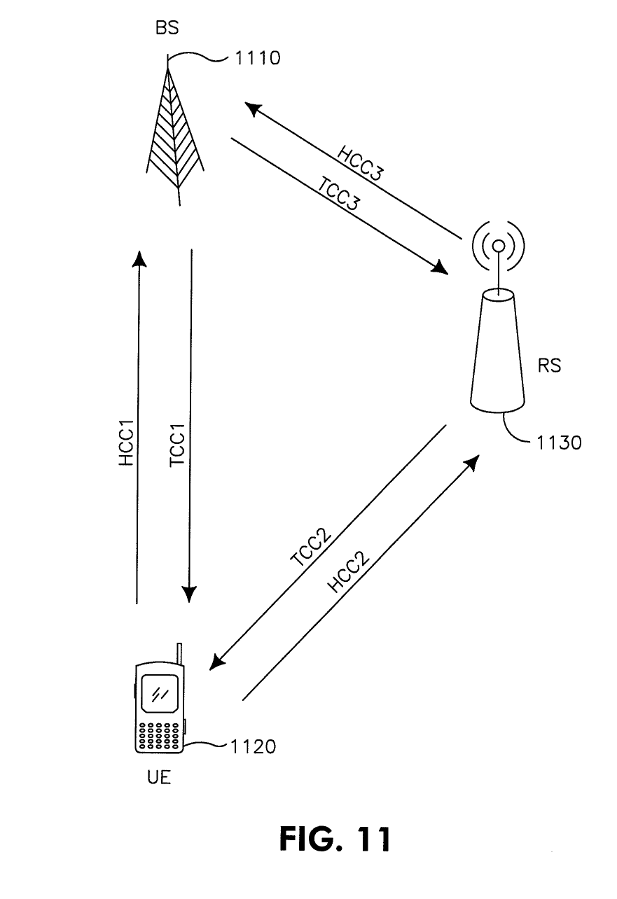

FIG. 11 shows control channels for the DL. The WTRU 1120 monitors a control channel transmitted by the BS 1110 (referred to as TCC1), that signals information regarding the transmissions from the BS 1110. The WTRU 1120 monitors a control channel transmitted by the RS 1130 (referred to as TCC2), that signals information regarding the transmissions from the RS 1130. Alternatively, TCC2 may be transmitted by the BS 1110 instead, but still signals information regarding the transmissions from the RS 1130. TCC1 and TCC2 may be combined in one control channel (i.e. a single TCC from BS 1110).

The RS 1130 monitors a control channel transmitted by the BS 1110 (referred to as TCC3), that signals information regarding the transmissions from the BS 1110. TCC1 and TCC3 may be the same control channel (i.e. a single TCC from BS 1110). The WTRU 1120 transmits a HARQ feedback control channel (referred to as HCC1) to the BS 1110. The WTRU 1120 transmits a HARQ feedback control channel (referred to as HCC2) to the RS 1130. The RS 1130 transmits a HARQ feedback control channel (referred to as HCC3) to the BS 1120. HCC1 and HCC2 may be the same control channel (i.e. a single HCC from WTRU 1120).

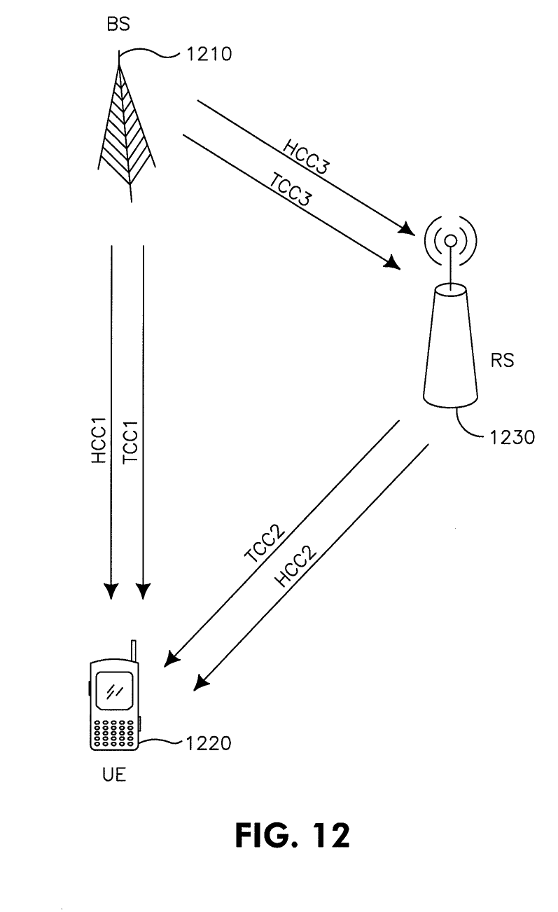

FIG. 12 shows an embodiment of the control channels for UL. The WTRU 1220 monitors a control channel transmitted by the BS 1210 (referred to as TCC1), that signals information regarding the transmissions from the WTRU 1220 (i.e. it instructs the WTRU 1220 when and/or what to transmit to the BS 1210). The WTRU 1220 monitors a control channel transmitted by the RS 1230 (referred to as TCC2), that signals information regarding the transmissions from the WTRU 1220 (i.e. it instructs the WTRU 1220 when and/or what to transmit to the RS 1230). Alternatively, TCC2 may be transmitted by the BS 1210 instead, or yet alternatively TCC1 and TCC2 may be the same control channel (e.g. a single TCC from BS 1210 to WTRU 1220 that instructs the WTRU 1220 when and/or what to transmit to either of or both the RS 1230 and BS 1210).

The RS 1230 monitors a control channel transmitted by the BS 1210 (referred to as TCC3), that signals information regarding the transmissions from the RS 1230 (i.e. it instructs the RS 1230 when and/or what to transmit to the BS 1210 and/or to the WTRU 1220). TCC1 and TCC3 may be the same control channel (i.e. a single TCC from BS 1210) to WTRU 1220 and/or RS 1230 that instructs the WTRU 1220 and RS 1230 when and/or what to transmit. The WTRU 1220 receives a HARQ feedback control channel (referred to as HCC1) from the BS 1210. The WTRU 1220 receives a HARQ feedback control channel (referred to as HCC2) from the RS 1230. The RS 1230 receives a HARQ feedback control channel (referred to as HCC3) from the BS 1210. HCC1 and HCC3 may be the same control channel (i.e. a single HCC from BS 1210). The UL control channels (TTCx or HCCx) are not necessarily the same as the DL control channels, although the same terms are used in the description.

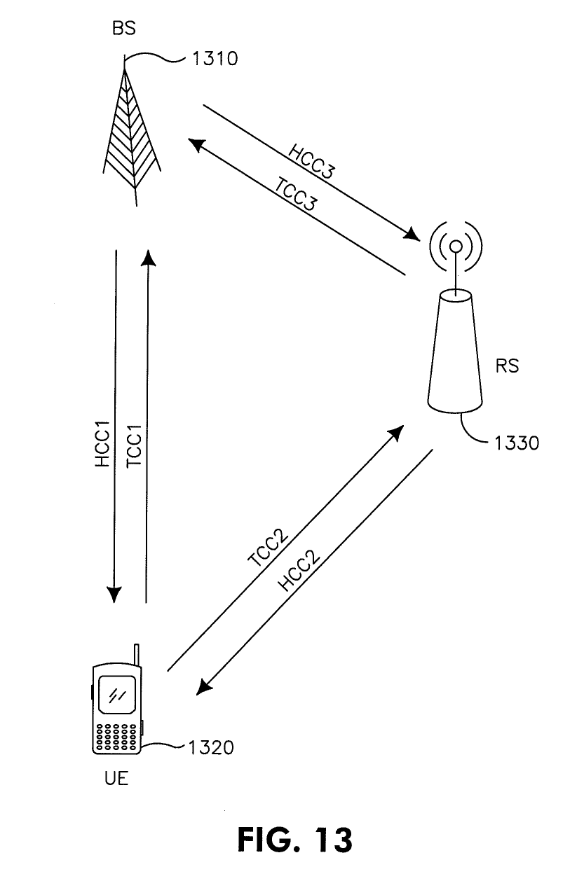

FIG. 13 shows another embodiment of the control channels for UL. Variant B describes a WTRU 1320 that transmits a control channel to the BS 1310 (referred to as TCC1), that signals information regarding the transmissions from the WTRU 1320. The WTRU 1320 transmits a control channel to the RS 1330 (referred to as TCC2), that signals information regarding the transmissions from the WTRU 1320. Alternatively, TCC1 and TCC2 may be the same control channel (i.e. a single TCC from WTRU 1320).

The RS 1330 transmits a control channel to the BS 1310 (referred to as TCC3), that signals information regarding the transmissions from the RS 1330. The WTRU 1320 receives a HARQ feedback control channel (referred to as HCC1) from the WTRU 1320. The WTRU 1320 receives a HARQ feedback control channel (referred to as HCC2) from the RS 1330. The RS 1330 receives a HARQ feedback control channel (referred to as HCC3) from the BS 1310. HCC1 and HCC3 may be the same control channel (i.e. a single HCC from BS 1310). The UL control channels (TTCx or HCCx) are not necessarily the same as the DL control channels, although the same terms were used in the description. Other variants are also possible via combining some aspects from the embodiments discussed herein.

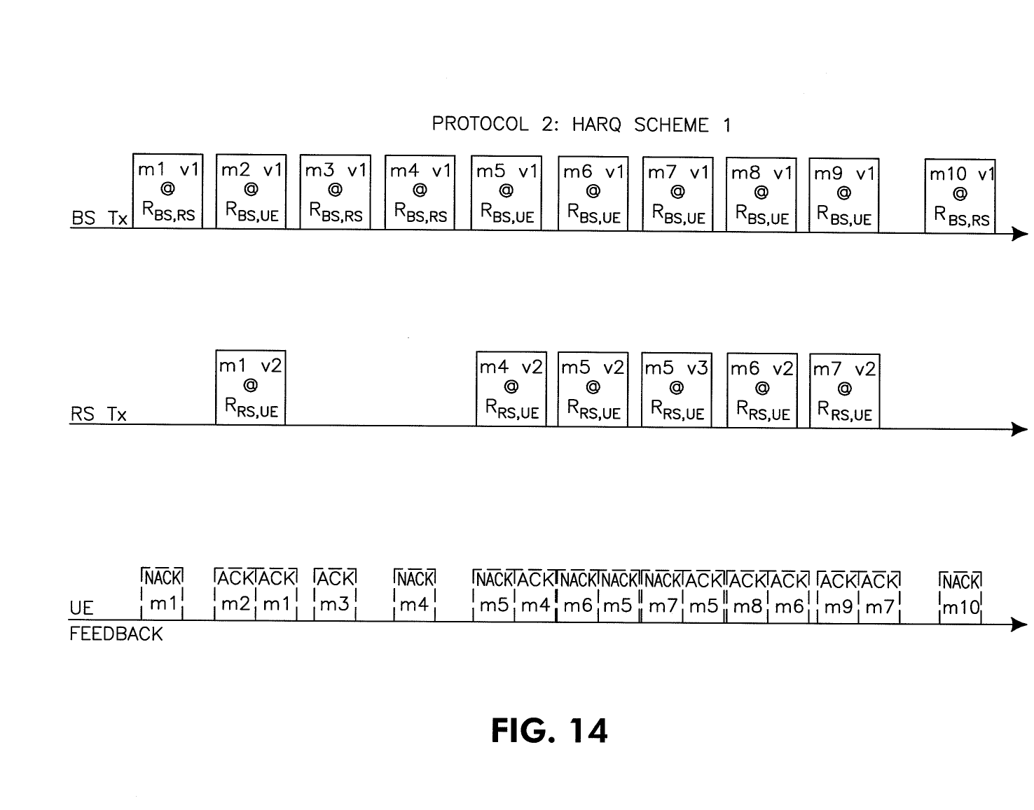

Described herein are operational schemes for protocol 1 and protocol 2. One embodiment of a DL scheme is shown in FIG. 14 that describes a HARQ scheme for Protocol 2 which has a full-duplex relay, i.e. the RS is capable of simultaneous reception and transmission (e.g. on different frequencies).

The BS sends data to the RS (preferably using an MCS suitable for the BS-RS link). In TTIs when the RS is expected to be (or is) busy transmitting to the WTRU, the BS may send data to the WTRU (possibly using an MCS suitable for the BS-WTRU link); the RS will/should also receive such transmissions from BS to WTRU, because of its full-duplex nature.

The RS sends data to the WTRU (preferably using an MCS suitable for the RS-WTRU link).

The WTRU receives up to two codewords (e.g. HARQ PDUs) in a TTI, one from BS and one from RS. This can be extended/generalized to more than 2 codewords, e.g. if MIMO transmission is used from BS and/or RS to WTRU, or if more than one RS is used. The codeword transmissions are described/indicated to the WTRU via control channel(s) (i.e. TCC).

The WTRU may send HARQ feedback (e.g. ACK/NACK) to indicate whether each of the two codewords has been received successfully or not. Such feedback can be sent using the HCC channel(s).

The RS may send HARQ feedback (e.g. ACK/NACK) to the BS to indicate whether a codeword transmitted by the BS has been received successfully or not by the RS. Such feedback can be sent using the HCC channel(s). If the HARQ feedback indicates that the RS has not successfully received the codeword (i.e. NACK or DTX), the BS may re-transmit. Retransmitted packets may have different IR version.

If the BS receives an ACK from the WTRU, the BS moves on to transmit the next message/packet.

If the BS receives an ACK from the RS, the BS moves on to transmit the next message/packet. HARQ retransmissions will be delegated to the RS.

If the RS does not receive an ACK from the WTRU, the RS will conduct (take care of) retransmissions to the WTRU, until the WTRU acknowledges (sends an ACK) or until HARQ retransmissions are exhausted (reach a limit). Retransmitted packets may have different IR version

The WTRU combines the received versions (e.g. HARQ combining) in order to improve the decoding of a given packet m. Common identifiers are employed by the BS and RS in order to enable the WTRU to recognize which packets to combine. Such identifiers can be in the form of (using the same) HARQ process ID, pre-defined TTI's (e.g. at TTI # x+y, the RS will send the packet received from BS in TTI # x), or any other identification form.

Flow control signals may also be used from RS to BS to stop new HARQ transmissions by the BS, when the RS is overloaded with HARQ retransmissions to the WTRU.

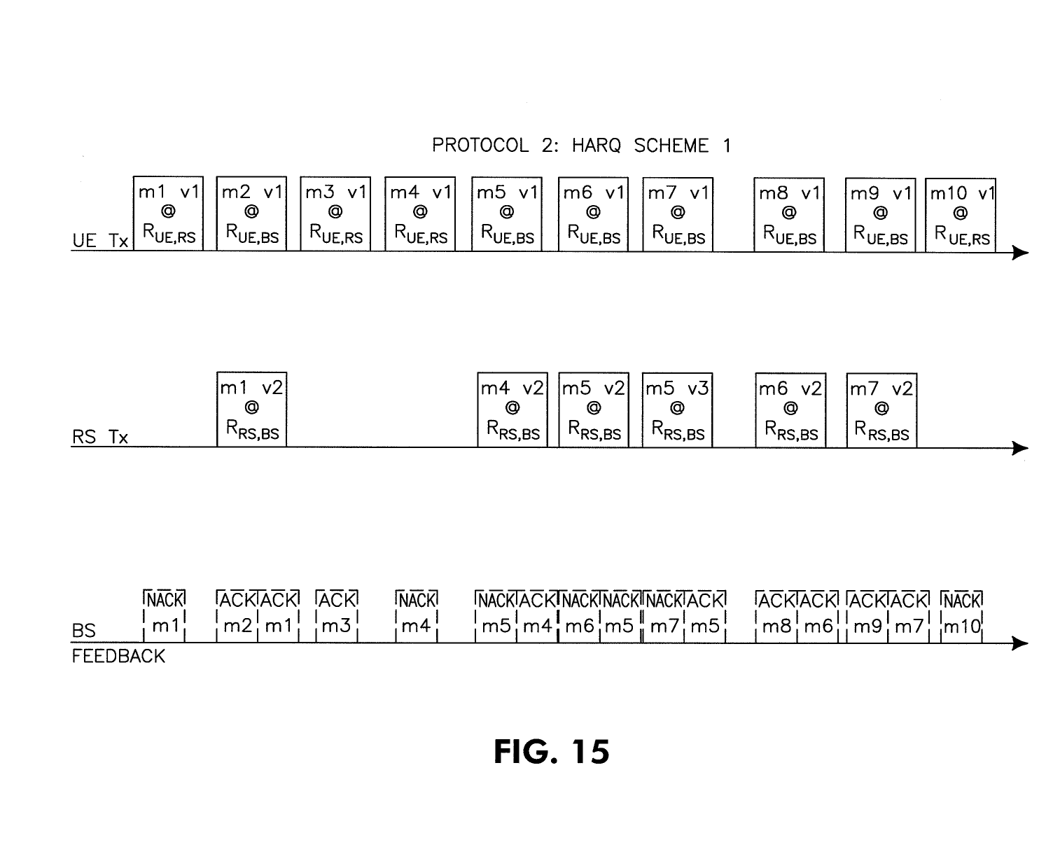

As shown in FIG. 15, the uplink drawing/figure is similar to that of downlink but with switching/re-labeling BS as WTRU, and WTRU as BS. The description is also similar; just replace BS by WTRU, and WTRU by BS. The scheme of FIG. 15 has a full-duplex relay; i.e. the RS is capable of simultaneous reception and transmission (e.g. on different frequencies). The WTRU sends data to the RS (possibly using an MCS suitable for the WTRU-RS link). In TTIs when the RS is expected to be (or is) busy transmitting to the BS, the WTRU may send data to the BS (preferably using an MCS suitable for the WTRU-BS link); the RS will/should also receive such transmissions from WTRU to BS, because of its full-duplex nature. The RS sends data to the BS using an MCS suitable for the RS-BS link.

The BS receives up to two codewords (e.g. HARQ PDUs) in a TTI, one from WTRU and one from RS. This can be extended/generalized to more than 2 codewords, e.g. if MIMO transmission is used from WTRU and/or RS to BS, or if more than one RS is used. The codeword transmissions are described/indicated via control channel(s) (i.e. TCC).

The BS may send HARQ feedback (e.g. ACK/NACK) to indicate whether each of the two codewords has been received successfully or not. Such feedback can be sent using the HCC channel(s).

The RS may send HARQ feedback (e.g. ACK/NACK) to the WTRU to indicate whether a codeword transmitted by the WTRU has been received successfully or not by the RS. Such feedback can be sent using the HCC channel(s). If the HARQ feedback indicates that the RS has not successfully received the codeword (i.e. NACK or DTX), the WTRU may re-transmit. Retransmitted packets will preferably have different IR version.

If the WTRU receives an ACK from the BS, the WTRU moves on to transmit the next message/packet. If the WTRU receives an ACK from the RS, the WTRU moves on to transmit the next message/packet. HARQ retransmissions will be delegated to the RS.

If the RS does not receive an ACK from the BS, the RS will conduct (take care of) retransmissions to the BS, until the BS acknowledges (sends an ACK) or until HARQ retransmissions are exhausted (e.g. reach a predetermined limit). Retransmitted packets may have different IR versions.

The BS combines the received versions (e.g. HARQ combining) in order to improve the decoding of a given packet m. Common identifiers are employed by the WTRU and RS in order to enable the BS to recognize which packets to combine. Such identifiers can be in the form of (using the same) HARQ process ID, pre-defined TTI's (e.g. at TTI # x+y, the RS will send the packet received from WTRU in TTI # x), or any other identification form.

Flow control signals may also be used from RS to WTRU to stop new HARQ transmissions by the WTRU, when the RS is overloaded with HARQ retransmissions to the BS.

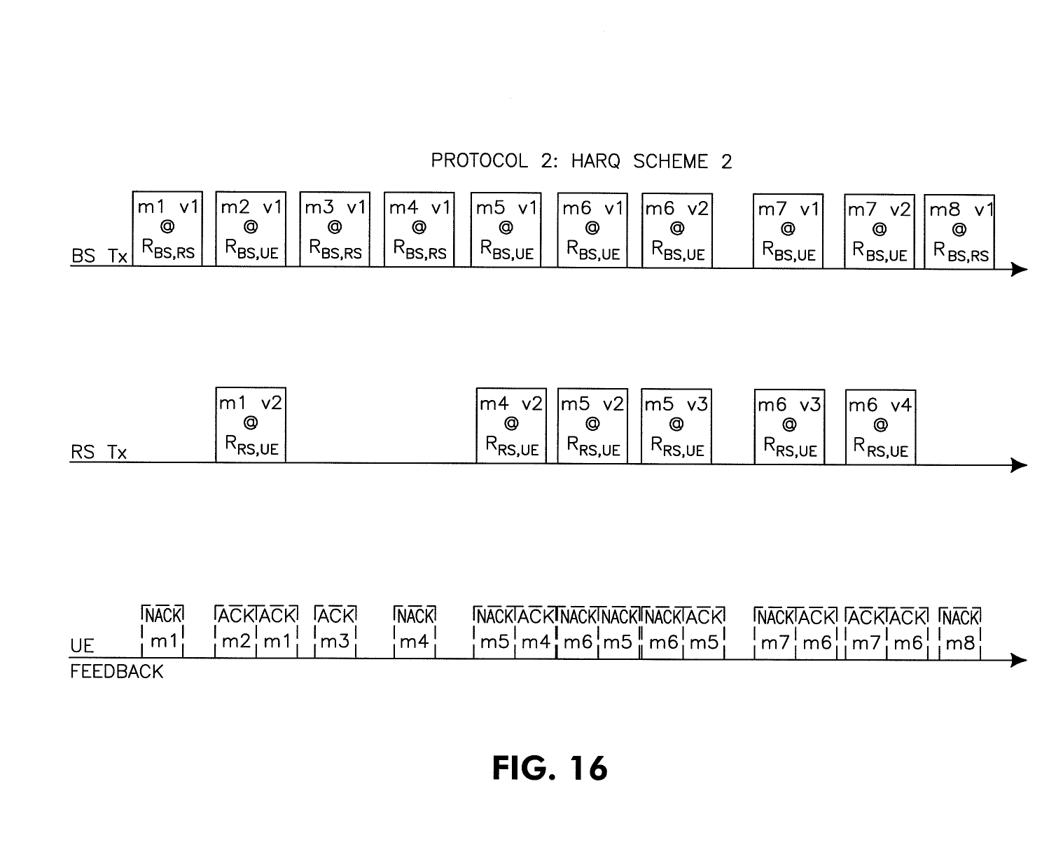

Another DL scheme is shown in FIG. 16. The following are differences from the DL scheme presented above. In TTIs when the RS is expected to be (or is) busy transmitting or re-transmitting to the WTRU, the BS will conduct (take care of) some HARQ retransmissions to the WTRU (preferably using an MCS suitable for the BS-UE link). Whether BS takes care of conducting retransmissions or not can be based on ACK/NACK feedback status from the RS and/or WTRU, and/or RS load. The uplink drawing/figure and description is similar to that of the DL in FIG. 16 but with switching/re-labeling BS as WTRU, and WTRU as BS.

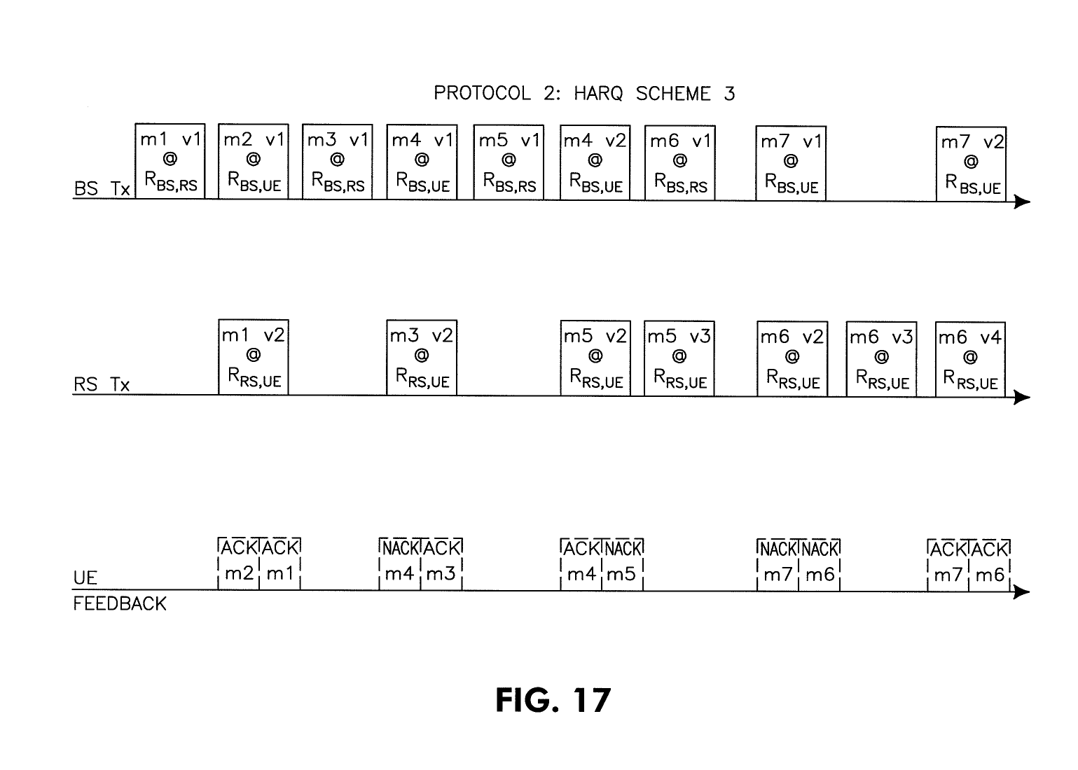

Another embodiment of a DL scheme is shown in FIG. 17 and has the following differences with respect to DL scheme embodiments discussed herein. A pair of TTI's is used; HARQ feedback is transmitted by the WTRU at the end of the latter TTI (as opposed to transmitting HARQ feedback in each TTI). This can also be generalized/extended to a ‘bundle’ of 2 or more TTI's instead of a ‘pair’ of TTI's. The uplink drawing/figure and description is similar to that of DL in FIG. 17 but with switching/re-labeling BS as WTRU, and WTRU as BS.

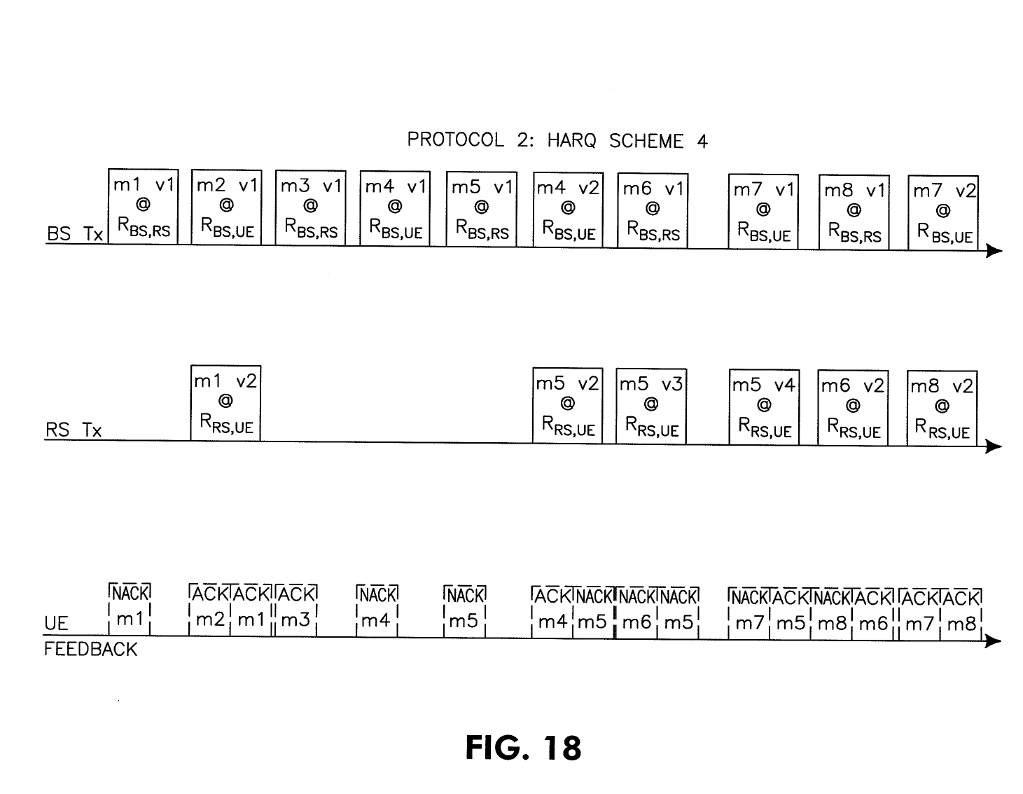

Another embodiment of a DL scheme is shown in FIG. 18 and has the following differences with respect to DL scheme embodiments discussed herein. HARQ retransmissions for some packets will not be delegated from the BS to the RS, but HARQ retransmissions for some other packets will be delegated from the BS to the RS. Whether to delegate or not can be based on ACK/NACK feedback status from the RS and/or WTRU, and/or RS load. The uplink drawing/figure and description is similar to that of downlink but with switching/re-labeling BS as WTRU, and WTRU as BS.

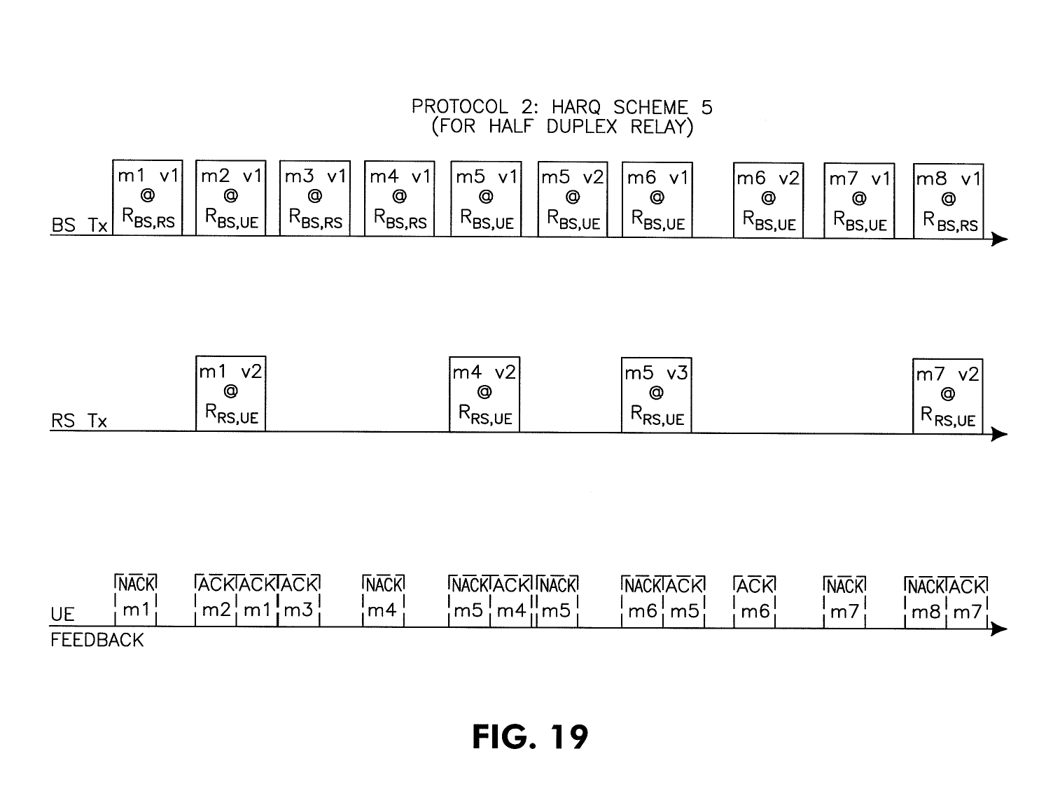

Another embodiment of a DL scheme is shown in FIG. 19 and has the following differences with respect to DL scheme embodiments discussed herein. This scheme has half-duplex relay; i.e. the RS is capable of either reception or transmission, but not both at the same time. HARQ retransmissions for some packets will not be delegated from the BS to the RS, but HARQ retransmissions for some other packets will be delegated from the BS to the RS. Whether to delegate or not can be based on whether the RS has received the packet from the BS (i.e. whether the RS was receiving or transmitting, since it's half-duplex); other factors such as ACK/NACK feedback status from the RS and/or WTRU, and/or RS load can also be considered. The uplink drawing/figure and description is similar to that of downlink but with switching/re-labeling BS as WTRU, and WTRU as BS.

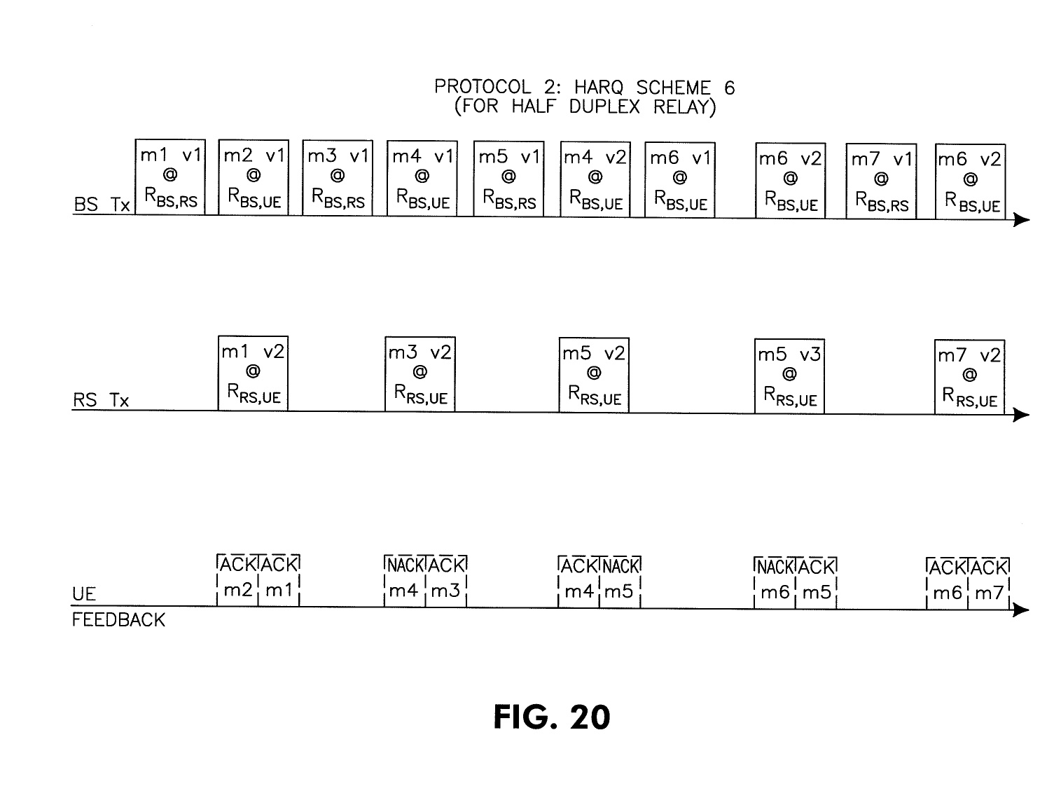

Another embodiment of a DL scheme is shown in FIG. 20 and has the following differences with respect to DL scheme embodiments discussed herein. A pair of TTI's is used; HARQ feedback is transmitted by the WTRU at the end of the latter TTI (as opposed to transmitting HARQ feedback in each TTI). This can also be generalized/extended to a ‘bundle’ of 2 or more TTI's instead of a ‘pair’ of TTI's. The uplink drawing/figure and description is similar to that of DL but with switching/re-labeling BS as WTRU, and WTRU as BS.

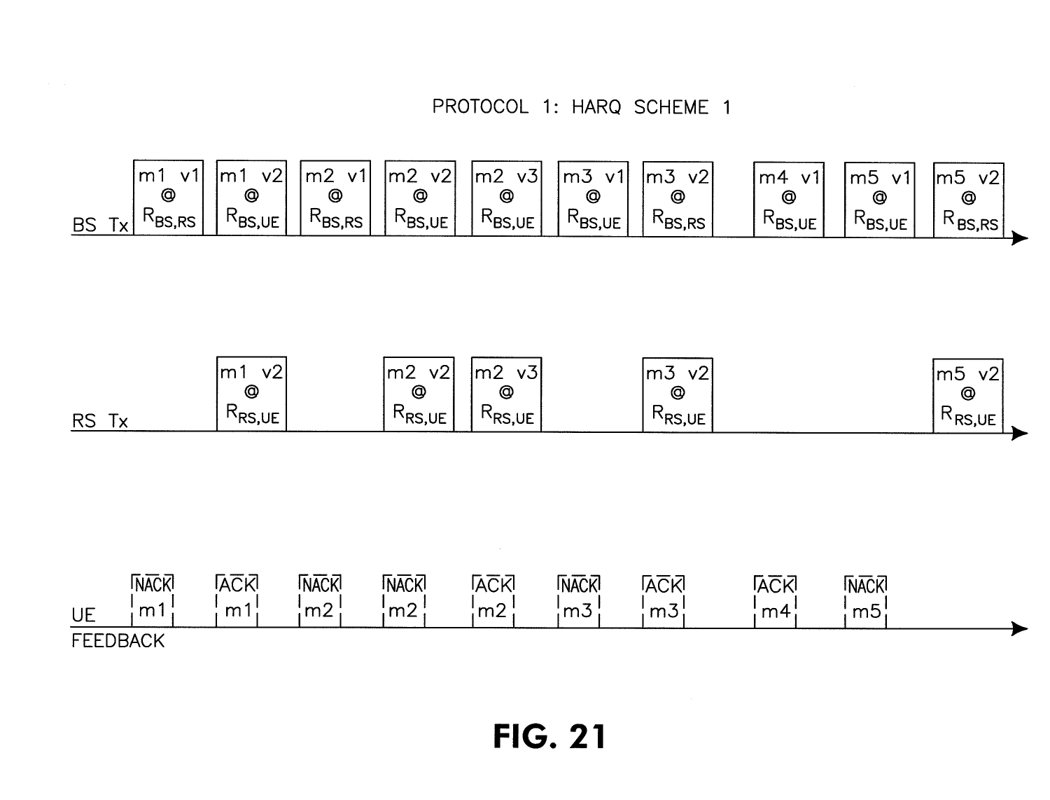

One embodiment of a DL scheme is shown in FIG. 21 for protocol 1. The BS sends data to the RS in a first TTI using an MCS suitable for the BS-RS link, or that considers the overall BS-RS, BS-WTRU, RS-WTRU links. The BS and RS send data to the WTRU in a subsequent TTI using an MCS suitable for the RS-WTRU link, or that considers the overall BS-WTRU and RS-WTRU links.

The WTRU receives a single codeword (e.g. HARQ PDU) in a TTI, that is transmitted either by the BS alone, or jointly (e.g. using a distributed space-time code) by both BS and RS, (or as a third possibility by the RS alone (not shown in FIG. 21)). This can be extended/generalized to multiple codewords, e.g. if MIMO transmission is used from BS and/or RS to WTRU. The codeword transmissions are described/indicated to the WTRU via control channel(s) (i.e. TCC).

The WTRU may send HARQ feedback (e.g. ACK/NACK) to indicate whether a codeword has been received successfully or not. Such feedback can be sent using the HCC channel(s).

The RS may send HARQ feedback (e.g. ACK/NACK) to the BS to indicate whether a codeword transmitted by the BS has been received successfully or not by the RS. Such feedback can be sent using the HCC channel(s). If the HARQ feedback indicates that the RS has not successfully received the codeword (i.e. NACK or DTX), the BS may re-transmit. Retransmitted packets will preferably have different IR version.

If the BS receives an ACK from the WTRU, the BS moves on to transmit the next message/packet. If the BS and/or RS do not receive an ACK from the WTRU, both the BS and RS will conduct (take care of) retransmissions to the WTRU (e.g. using a distributed space-time code), until the WTRU acknowledges (sends an ACK) or until HARQ retransmissions are exhausted (reach a limit). Retransmitted packets will preferably have different IR version.

The WTRU combines the received versions (e.g. HARQ combining) in order to improve the decoding of a given packet m. Common identifiers are employed by the BS and RS in order to enable the WTRU to recognize which packets to combine. Such identifiers can be in the form of (using the same) HARQ process ID, pre-defined TTI's (e.g. at TTI # x+y, the RS will send the packet received from BS in TTI # x), or any other identification form. The uplink drawing/figure and description is similar to that of downlink but with switching/re-labeling BS as WTRU, and WTRU as BS.

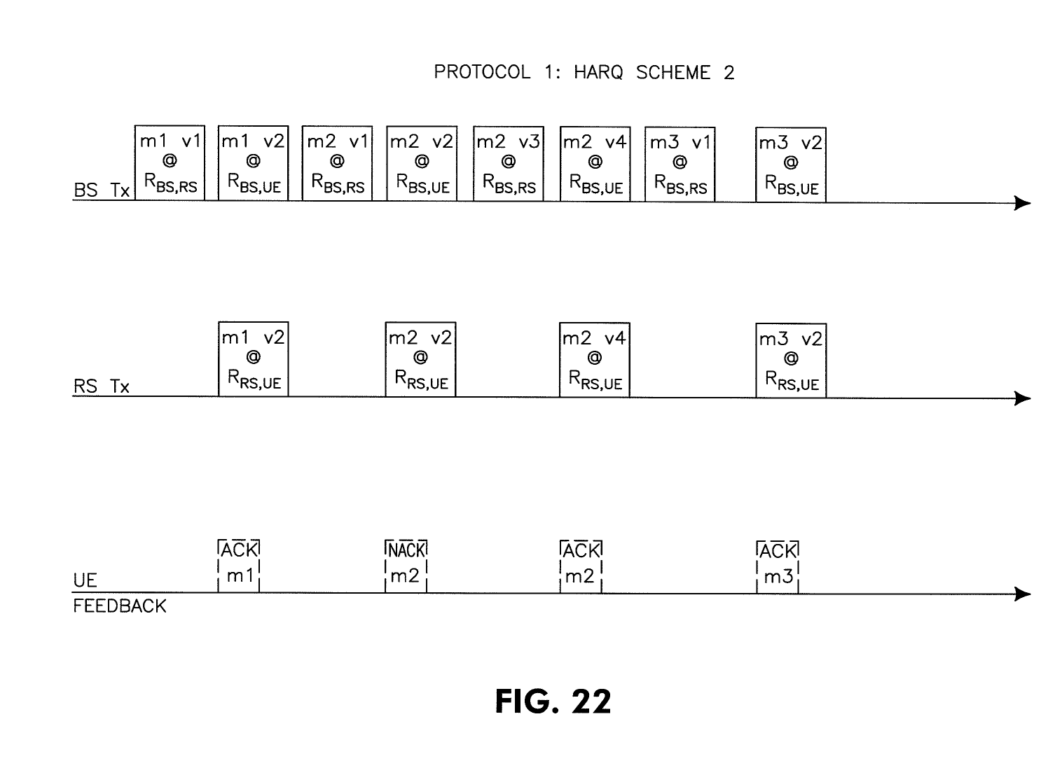

Another embodiment of a DL scheme is shown in FIG. 22 for protocol 1 and has the following differences with respect to DL scheme embodiments discussed herein. A pair of TTI's is used; HARQ feedback is transmitted by the WTRU at the end of the latter TTI (as opposed to transmitting HARQ feedback in each TTI). This can also be generalized/extended to a ‘bundle’ of 2 or more TTI's instead of a ‘pair’ of TTI's. The uplink drawing/figure and description is similar to that of downlink but with switching/re-labeling BS as WTRU, and WTRU as BS.

Described above were two embodiments for cooperative multiplexing. In general, the method and apparatus described embodies a transmission from a source to a destination via the help of a RS. The source can be a BS transmitting to a WTRU or vise versa. Phase 1 denotes the phase in time where the source is communicating to the RS. And phase 2 is when both the source and the RS communicate with the destination. The method and apparatus are directed at the case where the source and the RS form a distributed 2 antennae system transmitting following the multiplexing mode. This implies that the source and the RS will be transmitting two different streams of data to the destination.

Protocol 1 discussed above is an embodiment of a simple cooperative multiplexing scheme and protocol 2 is an embodiment of a split cooperative multiplexing scheme.

Structured in two (2) phases, the simple cooperative multiplexing schemes (SCM) differ from the simple 2-hop and cooperative diversity schemes in the second phase by enabling the BS and the RS to act as two (2) independent transmitters and the system to be viewed as a multiplexing type. Specifically, the BS and RS will send different codewords to the WTRU and their signals will interfere with each other. The WTRU will then use a SIC or other similar functional structure to distinguish between them.

As stated above, protocol 2 is an embodiment of a split cooperative multiplexing scheme. In the simple cooperative multiplexing scheme above, the RS receives the full message consisting of “b” bits in phase 1, but forwards to the WTRU in phase 2, only part of that message since the BS will be also transmitting to the WTRU at the same time. The split cooperative multiplexing scheme takes advantage of this “partial” transmission. In one embodiment, the scheme effectively shortens the first phase and makes the BS transmit to the RS only the bits that will be relayed to the WTRU in the multiplexing phase. The BS will need to know ahead of the start of phase 1 how the original b bits will be split into 2 portions, b_{RS} and b_{BS}, following the multiplexing mode in phase 2. Splitting the “b” bits can be executed at the MAC level or the PHY level. The original data dedicated to the WTRU from the beginning can be split according to the channel conditions and to accommodate simultaneous transmissions. Another embodiment concatenates two different messages intended to the WTRU and transmits using b_{RS} and b_{BS} for each in accordance to the channel constraints. These constraints are translated in terms of b_{RS} to b_{BS} ratio or T₁ to T₂ ratio. The BS will have two streams of data b_{RS} and b_{BS}. The BS will forward only b_{RS} to the RS in phase 1, and will transmit b_{BS}. to the WTRU in phase 2, assuming that b=b_{RS}+b_{BS}.

In an embodiment, the BS will transmit b_{RS} bits to the RS in phase 1 using a coding technique that allows only the RS to decode the transmitted codeword. In phase 2, the RS will forward the b_{RS} bits successfully decoded to the WTRU at the rate R_{RS-U} and the BS will transmit simultaneously b_{BS} bits with rate R_{BS-U}⁽²⁾.

In another embodiment, the BS will transmit b_{RS} bits to the RS in phase 1. The RS will be able to fully decode the transmitted message but in this embodiment other receivers will be able to decode some parts of the message. Let b₁ denote the bits that the WTRU is able to overhear and successfully extract from the BS-RS transmission in phase 1. b₂ denotes the bits that the WTRU receives in phase 2, such that b=b_{RS}+b_{BS}. As for phase 2, the BS will transmit b_{BS} bits with rate R_{BS-U}⁽²⁾, and simultaneously, the RS will forward the b_{RS}−b₁ bits to the WTRU at the rate R_{RS-U}.

In general, a method for signaling information in relay based wireless communications is disclosed. The method includes receiving a packet at a relay station (RS) from a transmitting station (TS), where the packet has scheduling information for the RS and acting on the scheduling information on an occurrence of a predetermined event. The scheduling information may be based on hybrid access repeat request (HARQ) processes and may be preconfigured by the TS. The TS may set the scheduling information to schedule relay transmissions in synchronization with transmitting station transmissions on a condition that the relay transmissions are transmitted. The scheduling information may be transmitted to the RS as a scheduling word, where the scheduling word further includes a list of HARQ process identifiers, each containing a receiving station identifier; a transmission time interval (TTI) and sub-carrier identifier for each HARQ process identifier; and a data transmission scheme for each HARQ process identifier. The method further includes partitioning a RS communication frame into a receive interval and a transmit interval, where the transmit interval is based on a list of transmission time interval (TTIs) in which the RS is scheduled to transmit and the RS receives on all other TTIs. The method further includes sending at least the scheduling information to a receiving station, where the TS does not transmit to the receiving station based on the scheduling information. The TS uses radio resources corresponding to the scheduling information for other purposes such as to control cross-interference. The scheduling information includes a relay station control indicator (RSCI) bit, where the RS independently schedules re-transmissions to a receiving station in a hybrid access repeat request (HARQ) process on a condition that the RSCI bit is set. The RS may include a plurality of RSs that are synchronized in a synchronized relay set (SRS) and all of the RSs in the SRS transmit and receive together. The method further includes transmitting feedback information on a single feedback channel from a receiving station, where the feedback information is transmitted at a power level greater than other transmissions. Channel information may be transmitted in the feedback information. The feedback information is transmitted to the TS without RS assistance. The method further includes receiving feedback information related to the packet at the RS, withholding the feedback information by the RS intended for the TS on a condition that the TS directly receives the feedback information, and relaying the feedback information to the TS on a condition that the TS will not otherwise receive the feedback information. The feedback information contains feedback information from a plurality of receiving stations associated with the RS.

In general, a method of relayed wireless communications includes establishing a new transmission state, changing to a first phase re-transmission state on a condition that the transmitting station (TS) receives a non-acknowledgement (NACK) and a relay non-acknowledgement (R-NACK), changing to a second phase retransmission state on a condition that the TS receives a NACK from the receiving station and a relay acknowledgement (R-ACK) from a relay station (RS), and returning to the new transmission state on a condition that an acknowledgment (ACK) is received from the receiving station. The method further includes returning to the new transmission state on a condition that a timeout condition exists. The first phase retransmission state is maintained on a condition that a NACK is received and an R-NACK is received and the second phase retransmission state is maintained on a condition that a NACK is received. The method includes changing from the new transmission state to the second phase retransmission state on a condition that a NACK is received and an R-ACK is received.

In general, a method of using distributed and centralized scheduling in wireless communications includes identifying an association root node (ARN) for a wireless transmit receive unit (WTRU) wherein the ARN is associated with the WTRU, receiving data and scheduling information at the ARN from a super-ordinate node using distributed scheduling, scheduling a transmission from the ARN to the WTRU, wherein the ARN schedules the transmission to the WTRU using centralized scheduling, and establishing cooperative 2-hop timing between the ARN and at least one sub-ordinate node and the WTRU.

In general, a method for scheduling a transmission in wireless communications includes sending the transmission to a relay station (RS), receiving an acknowledgement from the RS, scheduling the transmission from the BS to a wireless transmit receive unit (WTRU) on a condition that the WTRU is the intended recipient of the transmission and is associated with the BS, signaling the RS to take over scheduling of the transmission from the BS on a condition that the WTRU is not associated with the BS, receiving an acknowledgement (ACK) from one of the RS and WTRU, and removing the transmission from a hybrid automatic retransmission request (HARQ) buffer in the BS on a condition that the ACK is received by the BS.

In general, a method for transmitting in a cooperative relay based wireless communications includes receiving a first message from a first station in a first phase in a first time interval, and receiving a modified first message from a relay station in a second phase of a second time interval, wherein the modified first message is based on a version of the first message received by the relay station from the first station in the first phase of the first time interval. The second time interval is not contiguous with the first time interval. The method further includes receiving a second message from the first station in the second phase, where the receiving is done using a multi-user detector or is done using a sequence interference cancellation (SIC) receiver. The method further includes combining received messages to improve decoding, where the combining is hybrid automatic repeat request (HARQ) combining. The first message and the second message are two medium access control (MAC) packet data units (PDUs) flows. The method further includes using at least one transmitting control channel to signal between the first station, the relay station and a receiving station, and using at least one hybrid automatic repeat request (HARQ) control channel to send feedback information between the first station, the relay station and the receiving station. The method further includes receiving at least two codewords in a transmission time interval (TTI), where one codeword is received from the relay station and the other codeword is received from the first station. The method further includes sending HARQ feedback to indicate whether each of the at least two codewords has been received. The first phase denotes the phase in time where the first station is communicating with the relay station and the second phase denotes the time where the first station and the relay station communicate with a receiving station.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a software defined radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module or a Near Field Communication (NFC) Module.

What is claimed is:

1. A method for signaling information in relay based wireless communications, the method comprising:
receiving a packet at a relay station (RS) from a transmitting station (TS), wherein the packet has scheduling information for the RS; and
acting on at least the scheduling information on an occurrence of a predetermined event.

2. The method as in claim 1, wherein the scheduling information is based on hybrid access repeat request (HARQ) processes.

3. The method as in claim 1, wherein the scheduling information is preconfigured by the TS.

4. The method as in claim 1, wherein the TS sets the scheduling information to schedule relay transmissions in synchronization with transmitting station transmissions on a condition that the relay transmissions are transmitted.

5. The method as in claim 1, wherein the scheduling information is transmitted to the RS as a scheduling word.

6. The method as in claim 5, wherein the scheduling word further comprises:
a list of HARQ process identifiers, wherein a HARQ process identifier contains a receiving station identifier;
a transmission time interval (TTI) and sub-carrier identifier for each HARQ process identifier; and
a data transmission scheme for each HARQ process identifier.

7. The method as in claim 1, further comprising:
partitioning a RS communication frame into a receive interval and a transmit interval, wherein the transmit interval is based on a list of transmission time interval (TTIs) in which the RS is scheduled to transmit and the RS receives on all other TTIs.

8. The method as in claim 1, further comprising:
sending at least the scheduling information to a receiving station, wherein the TS does not transmit to the receiving station based on the scheduling information.

9. The method as in claim 8, wherein the TS uses radio resources corresponding to the scheduling information for other purposes.

10. The method as in claim 9, wherein the radio resources not used to transmit scheduled transmission to the WTRU are used to control cross-interference.

11. The method as in claim 1, wherein the scheduling information includes a relay station control indicator (RSCI) bit, wherein the RS independently schedules re-transmissions to a receiving station in a hybrid access repeat request (HARQ) process on a condition that the RSCI bit is set.

12. The method as in claim 1, wherein the RS further comprises a plurality of RSs that are synchronized in a synchronized relay set (SRS) and all of the RSs in the SRS transmit and receive together.

13. The method as in claim 1, further comprising:
transmitting feedback information on a single feedback channel from a receiving station.

14. The method as in claim 13, wherein the feedback information is transmitted at a power level greater than other transmissions.

15. The method as in claim 13, wherein channel information is transmitted in the feedback information.

16. The method as in claim 13, wherein the feedback information is transmitted to the TS without RS assistance.

17. The method as in claim 1, further comprising:
receiving feedback information related to the packet at the RS.

18. The method as in claim 17, further comprising:
withholding the feedback information by the RS intended for the TS on a condition that the TS directly receives the feedback information.

19. The method as in claim 17, further comprising:
relaying the feedback information to the TS on a condition that the TS will not otherwise receive the feedback information.

20. The method as in claim 13, wherein the feedback information contains feedback information from a plurality of receiving stations associated with the RS.

21. A method of relayed wireless communications, the method comprising:
establishing a new transmission state;
changing to a first phase re-transmission state on a condition that the transmitting station (TS) receives a non-acknowledgement (NACK) and a relay non-acknowledgement (R-NACK);
changing to a second phase retransmission state on a condition that the TS receives a NACK from the receiving station and a relay acknowledgement (R-ACK) from a relay station (RS); and
returning to the new transmission state on a condition that an acknowledgment (ACK) is received from the receiving station.

22. The method as in of claim 21, further comprising returning to the new transmission state on a condition that a timeout condition exists.

23. The method as in claim 21, wherein the first phase retransmission state is maintained on a condition that a NACK is received and an R-NACK is received.

24. The method as in claim 21, wherein the second phase retransmission state is maintained on a condition that a NACK is received.

25. The method as in claim 21, further comprising:
changing from the new transmission state to the second phase retransmission state on a condition that a NACK is received and an R-ACK is received.

26. A method of using distributed and centralized scheduling in wireless communications comprising:
identifying an association root node (ARN) for a wireless transmit receive unit (WTRU) wherein the ARN is associated with the WTRU;
receiving data and scheduling information at the ARN from a super-ordinate node using distributed scheduling;
scheduling a transmission from the ARN to the WTRU, wherein the ARN schedules the transmission to the WTRU using centralized scheduling; and
establishing cooperative 2-hop timing between the ARN and at least one sub-ordinate node and the WTRU.

27. A method for scheduling a transmission in wireless communications comprising:
sending the transmission to a relay station (RS);
receiving an acknowledgement from the RS;
scheduling the transmission from the BS to a wireless transmit receive unit (WTRU) on a condition that the WTRU is the intended recipient of the transmission and is associated with the BS;
signaling the RS to take over scheduling of the transmission from the BS on a condition that the WTRU is not associated with the BS;
receiving an acknowledgement (ACK) from one of the RS and WTRU; and
removing the transmission from a hybrid automatic retransmission request (HARQ) buffer in the BS on a condition that the ACK is received by the BS.

28. A method for transmitting in a cooperative relay based wireless communications, the method comprising:
receiving a first message from a first station in a first phase in a first time interval; and
receiving a modified first message from a relay station in a second phase of a second time interval, wherein the modified first message is based on a version of the first message received by the relay station from the first station in the first phase of the first time interval.

29. The method as in claim 28, wherein the second time interval is not contiguous with the first time interval.

30. The method as in claim 28, further comprising receiving a second message from the first station in the second phase.

31. The method as in claim 28, wherein the receiving is done using a multi-user detector.

32. The method as in claim 28, wherein the receiving is done using a sequence interference cancellation (SIC) receiver.

33. The method as in claim 28, further comprising:
combining received messages to improve decoding.

34. The method as in claim 33, wherein the combining is hybrid automatic repeat request (HARQ) combining.

35. The method as in claim 28, wherein the first message and the second message are two medium access control (MAC) packet data units (PDUs) flows.

36. The method as in claim 28, further comprising:
using at least one transmitting control channel to signal between the first station, the relay station and a receiving station; and
using at least one hybrid automatic repeat request (HARQ) control channel to send feedback information between the first station, the relay station and the receiving station.

37. The method as in claim 28, further comprising:
receiving at least two codewords in a transmission time interval (TTI).

38. The method as in claim 37, wherein one codeword is received from the relay station and the other codeword is received from the first station.

39. The method as in claim 37, further comprising:
sending HARQ feedback to indicate whether each of the at least two codewords has been received.

40. The method as in claim 28, wherein the first phase denotes the phase in time where the first station is communicating with the relay station.

41. The method as in claim 28, wherein the second phase denotes the time where the first station and the relay station communicate with a receiving station.
